(19) United States
(12) Patent Application Publication
(10) Pub. No.: US 2017/0024363 A1
(43) Pub. Date: Jan. 26, 2017

(54) System and Method for Dynamic Predictive Analytics for Pattern Search and Publishing Engine

(71) Applicants: Dan Tocchini, San Francisco, CA (US); Henri Bergius, Berlin (DE)

(72) Inventors: Dan Tocchini, San Francisco, CA (US); Henri Bergius, Berlin (DE)

(21) Appl. No.: 15/188,977

(22) Filed: Jun. 21, 2016

Related U.S. Application Data
(60) Provisional application No. 62/182,564, filed on Jun. 21, 2015.

(51) Int. Cl. G06F 17/21; G06F 17/27; G06N 7/00; G06F 17/30

(52) U.S. Cl. CPC G06F 17/212; G06F 17/3089; G06F 17/30598; G06F 17/2705; G06N 7/005

(57) ABSTRACT

The present invention provides systems and methods that automate the presentation of e-content in a high quality, magazine-like manner, and are customizable to the taste of individual users and/or the audience.

### INCORPORATION BY REFERENCE

This application claims the benefit of priority under 35 U.S.C. 119(e) to the filing date of U.S. provisional patent application No. 62/182,564 “System and Method for Dynamic Probabilistic Predictive Analytics for Pattern Search and Publishing Engine” which was filed on Jun. 21, 2015, and which are incorporated herein by reference in their entirety.

### FIELD OF INVENTION

The present invention is directed generally to a system and method for consuming and presenting digital content. In particular, the system and method may be used for consuming and presenting digital content such as a blog on computers, tablets, cellular phones, etc.

### BACKGROUND OF THE INVENTION

The present invention relates to systems and methods for presenting electronic content (e-content) with a high quality magazine-like presentation, which can be tailored to the taste of individual users and/or the audience.

Since the existence of the Internet, publishing content has been made easier by the widespread availability of Internet connections and advent of software. However, because of the limitation of web technologies, an attractive presentation of the content is traded off for ease of the flow of the e-content. For examples, network bandwidth limitation favors texts over images, and the lack of sophisticated and advanced e-content publishing software forces web publishers to plainly stack pieces of the content one on another. To overcome this plain look, web publishers currently have to layout the content manually similar to laying out a print magazine. Without a doubt, this process is time consuming and inhibits e-content dissemination from being instantaneous.

For example, FIG. 1 illustrates the current stacking layout of a web page. As it is shown, the owner's photo is not clear because it is a distance shot and the photo background is unnecessary. All texts on the blog have same font and font size, so the audience does not know what message is important. Thumbnail images of different sizes are placed everywhere, disorganized and random, so much so that they make the blog look unpleasing to the eye.

To compound the problem, publishers provide an increasing amount of content items to users through digital distribution channels, and users access these content items through various client devices. However, different client devices have different capabilities for displaying content items. For example, different client devices have different display areas, different display resolutions, different content download speeds, and different processing capabilities. These variations in display capabilities make it difficult for publishers to present content items on different client devices in a consistent manner.

For example, if a publisher of a digital magazine seeks to display a table of contents for a digital magazine or for a section of the digital magazine, the number of content items displayed by the table of contents may vary based on the client device. This variation in displayed content items may be based on variations in display resolutions or display areas of different client devices. The wide variety of client devices used to present content items makes use of device-specific display algorithms impractical. Some conventional techniques for displaying a table of contents shrink the display size of each content item to display all content items in a display area or exclude some content items from display. However, these techniques limit the ability of a user to view a comprehensive listing of the content items in a digital magazine or a section of the digital magazine.

The proliferation of lightweight, portable computing devices with various screen sizes has lead to a high demand for software applications that can displayed in either landscape or portrait orientations, depending on a user's viewing preference. Because switching a handheld computing device, such as a smartphone or a tablet computer, between landscape and portrait orientations involves simply adjusting how the device is being held, the user may choose to switch back and forth between orientations at will.

The poor quality of the layout of web content on portable computing devices stems in part from the challenges associated with translating web content designed to be viewed on one display device to one or more different display devices. Each display device may have different dimensions and resolution. An article from a publisher may contain, for example, a title, subtitle, by-line, dateline, text, pull-quotes, images, and captions, which are collectively referred to as the assets of the article. To accommodate the variety of assets of an article, a sophisticated layout may be required. However, such a sophisticated layout may not translate well between display devices having different dimensions and resolution. Such a sophisticated layout has previously also been time consuming to create, since the articles had typically needed to be laid out manually by the publisher.

To design an audience-winning layout, web publishers must pay attention to the rhythm of the design elements of the layout. Rhythm is a recurring pattern of elements, such as lines, forms, logos, images, fonts, font sizes, line spacing, tiles, size of tiles, element spacing, colors, that create a sense of direction or a sense of movement. In layout, the goal is to create a “harmonious whole”. The eye should not be distracted by disorganized, randomly placed elements, but should be led through the composition. Furthermore, the rhythms could go horizontal or vertical or both. By the repetitive use of an element to create a pattern within a given composition, these elements serve to unify the work into a sound composition. Therefore, mastering the uses of horizontal and vertical rhythms is the key to a winning layout.

Recently, web publishers have taken a step further by applying polyrhythmic designs to layouts. Polyrhythmic design is the simultaneous use of two or more conflicting rhythms that are not readily perceived as derivatives of one another to highlight the main rhythm. This method is used widely in drama, where protagonists overcomes antagonists, and music, where main rhythms are intertwined with a cross-beat rhythm to express a conflict/challenge.

Despite the sophistication of design techniques, the current publishing software systems treat the input HTML or XML content as a black box; that is, the publishing systems provide a container to house the content, but do not analyze the content for an optimal and rhythmic layout. The end result is that the content is displayed disconnected with other content on the web page in either a vertical section of the web page or a tile. The vertical sections stack on top of each other in some order. The tiles are a marginal improvement over the vertical stack by utilizing the horizontal sections of the web page. However, rows of tiles are still stacked on top of each other. Each of the containers, vertical section or tile, has a different layout accompanying the source content. It is inevitable that two adjacent containers would have contrasting layouts, and would negatively affect the overall aesthetics of the web page.

Thus, it is desirable to have both the ease of publishing e-content, and a high quality, magazine-like, and customized presentation of the content, given that the Internet bandwidth has been improved so much that images are displayed as equally efficient as texts. That is, desirable systems and methods of presenting e-content would automatically analyze a content, which comprises texts, images, and media clips, and present the content in an appealing, high quality, and magazine-like manner tailored to individual users and audiences' taste.

### OBJECTIVE OF THE INVENTION

Accordingly, it is the object of this invention to provide a system and method rhythmic and polyrhythmic pattern search and publishing content in a high quality, magazine-like manner.

It is also the object of this invention to provide a system and methods wherein the published content is in one or more rhythms that hold the designs together such that the design elements do not contradict or distract form one another.

It is also the object of this invention to provide systems and methods of automatic electronic content publishing that is customizable to individual users' and audiences' taste.

It is also the object of this invention to provide systems and methods of automatic electronic content publishing that comprises texts, images, and media clips.

It is also the object of this invention to provide systems and methods of automatic electronic content publishing that provides for a content flattening engine that receives and analyzes to be-published content.

It is also the object of this invention for the content flattening engine to dissect the content into units of texts, images, and/or media clips while maintaining properties such as number of works, font type, image size and resolution, image aspect ratio, image orientation, media clip size and type, video blocks, etc.

It is also the object of this invention for the content flattening engine to employ a plurality of techniques, including but not limited to parsing the incoming content stream.

It is also the object of this invention to provide systems and methods of automatic electronic content publishing that provides for an enrichment engine that enriches the elements of the content.

It is also the object of this invention for the enrichment engine to reformat texts as to font, color, styles, and/or to reflow texts to fit harmoniously with the whole layout.

It is also the object of this invention for the enrichment engine to analyze, crop, resize, and/or modify resolution of images to increase their aesthetic and that of the whole layout.

It is also the object of this invention for the enrichment engine to splice, cut, and/or downscale media clips to fit the other content elements and boost the displaying performance of the web page.

It is also the object of this invention for the enrichment engine to track and update the metadata to reflect the changes being made.

It is also the object of this invention to provide systems and methods of automatic electronic content publishing that provides for a layout engine that pair the incoming content with an optimal layout in a large repository of layout templates.

It is also the object of this invention for the layout engine to use the content's metadata, which set forth the parameter for search, to pair the incoming content with the optimal layout

It is also the object of this invention for the layout engine to provide a pathfinding algorithm to efficiently search through the template repository for an optimal layout.

It is also the object of this invention for the layout engine to employ the use of heuristics based on the knowledge of templates in the repository and/or the users' predefined rules.

It is also the object of this invention for the layout engine to build up a weighted heuristic engine capable of automatically selecting an optimal layout based on the user's taste and experience.

It is also the object of this invention to provide systems and methods of automatic electronic content publishing that provides for a presentation engine that receives and inputs content and the selected template.

It is also the object of this invention for the presentation engine to place content elements in the designated positions of the selected layout template, relying on the composed metadata.

It is also the object of this invention to provide systems and methods of automatic electronic content publishing to provide for a user friendly interface to aid web publishers and designers in designing layout templates and saving them to the repository.

It is also the object of this invention to provide systems and methods of automatic electronic content publishing to provide for a user friendly interface to aid users in managing the layout repository and categorizing the layout templates.

It is also the object of this invention to provide systems and methods of automatic electronic content publishing to decouple the design aspect and the technology aspect of web publishing in order to open up new opportunity for a marketplace of third party designers' layout templates.

It is also the object of this invention to provide systems and methods to automatically determine the preexisting rhythmic and polyrhythmic harmony of electronic content to be published.

It is further the object of this invention to provide systems and methods to automatically assign pre-computed layouts pending a satisfactory degree of preexisting harmony inherent within the content, thereby, conserving computational resources.

It is also the object of this invention to provide a system and methods to automatically assign at least one optimal layout in the event numerous equally optimal layouts result from content processing, thereby, ensuring content will be published consistently without failure.

It is also the object of this invention to employ a pre-existing method of computer processing in a new and novel way for the purpose of achieving magazine-like quality webpages. Experts in the fields of computer science and artificial intelligence know this method, as “table driven event processing.” The new and novel adaptation of this method is herein referred to as decision graph processing.

It is further the object of this invention, by utilizing said method, to reduce and balance the amount of computational resources required to process a near infinite number of possible design combinations in little to no time at all.

It is further the object of this invention to create an artificial intelligence (“AI”) engine capable of learning and evolving its designs according to popular trends and user preference history. Said AI may incorporate state of the art methods to calculate probabilities and stochastically make design decisions resulting in rhythmic and polyrhythmic patterns.

It is further the object of this invention to provide systems and methods for the AI engine to evaluate the validity of each decision against a set of constraint rules and Machine Learning classifiers.

It is further the object of this invention to provide systems and methods wherein if a rule is broken or the result is classified as invalid, the AI backtracks to the nearest valid decision point to try a new path, never pursuing a failed decision path more than once.

It is further the object of this invention to employ said method to discern aesthetically pleasing, and magazine-like quality typography for individual websites created by the present invention based on the user's taste and preference.

It is further the object of this invention to employ said method to discern aesthetically pleasing, and magazine-like quality color schemes for individual websites created by the present invention based on the user's taste and preference.

It is further the object of this invention to employ said method to discern aesthetically pleasing, and magazine-like quality decoration for individual websites created by the present invention based on the user's taste and preference.

It is further the object of this invention to employ said method to discern aesthetically pleasing, and magazine-like quality animation for individual websites created by the present invention based on the user's taste and preference.

It is further the object of this invention to employ said method to discern aesthetically pleasing, and magazine-like quality layouts for individual websites created by the present invention based on the user's taste and preference.

It is further the object of this invention to employ said method to discern aesthetically pleasing, and magazine-like quality navigation tools for individual websites created by the present invention based on the user's taste and preference.

It is further the object of this invention to provide systems and methods employing predictive analytic architecture for the purpose of predicting likely patterns by aggregating, analyzing, and extrapolating or interpolating data with constraint satisfaction.

It is further the object of this invention to provide systems and methods to narrow or channel AI solution methods governed by randomness to the user's taste and preference via use of soft constraint methods, thus preserving the benefits of randomness while satisfying user's taste and preference.

It is further the object of this invention to provide systems and methods of determining, adapting, and evolving the resulting rhythmic and polyrhythmic magazine-like quality webpage to any and all forms of display types, thus maintaining output quality across all devices requesting said webpage.

It is further the object of this invention to provide systems and methods of evolving the systems prediction analytics through the use of, but not limited to, data research, machine learning, and pattern recognition to produce the most fashionable, culturally apt, and aesthetically pleasing designs consistently without error.

### SUMMARY OF THE INVENTION

In one aspect of the invention, a computer-implemented system, comprising: a content flattening engine, which in operation, accepts a plurality of content from a dynamically aggregated feed of content or from an user input; parses and dissects the content into units of text and or media file and recording a plurality of attributes and properties of the units; categorizes the units based on the attributes and the properties; a content enrichment engine, which in operation, enriches the units according to the attributes and the properties by reformatting and resizing the units into a plurality of processed units for optimization of harmonious fitment and displaying performance of a layout; a layout engine, which in operation, accepts the processed units and matching the processed units to the layout wherein the layout is selected from a repository of layout templates; a presentation engine, which in operation, integrates the processed units into a designated position of the layout; requests the enrichment engine to further reformat the processed units in order to snug fit the processed units into the layout resulting a final ready layout; presents the final ready layout.

In one embodiment, the layout engine assigns a preference score of a selected layout to a heuristics database in order to subsequently recommend a preferred layout to a user.

In one embodiment, the final ready layout contains a rhythmic or polyrhythmic pattern.

In one embodiment, the content is comprised of texts, images, videos, and audio feeds.

In one embodiment, the content is dynamically aggregated from a content source comprising web pages, web feeds and social network platforms.

In one embodiment, the attribute is selected from a group consisted of number of words, font type, font size, image size, image resolution, image aspect ratio, image orientation, media clip type, video blocks, media clip size, media type, size of an object in an image, position of an object in an image, content of of an objection in an image.

In one embodiment, the properties are metadata.

In one embodiment, wherein the enrichment process is comprised of reformatting color of a text, reformatting style of a text, reformatting font of a text, reformatting size of a text, reformatting size of an image, reformatting resolution of an image, reformatting borders of an image, reformatting zoom of an image, reformatting resolution of a media clip, reformatting length of a media clip, reformatting size of a media clip.

In one embodiment, the properties and attributes of the processed unit are updated to be consistent with the enrichment process.

In one embodiment, the metadata of the processed unit are updated to be consistent with the enrichment process.

In one embodiment, the layout engine uses an algorithm to match the processed units to the layout wherein the layout is selected from a repository of layout templates. In one embodiment, the algorithm enables the final layout to contain a rhythmic or a polyrhythmic pattern. In one embodiment, the algorithm enables the final layout to contain a harmonious tiling pattern.

In one embodiment, the final ready layout is an arbitrary, well-formed, HTML file.

In another aspect of the invention, a method comprising accepting a plurality of content from dynamically aggregated feed of content or an user input; parsing and dissecting the content into units of text and or media file and recording a plurality of attributes and properties of the unit; categorizing the units based on the attributes and the properties; enriching the units according to the attributes and the properties by reformatting and resizing the units into a plurality of processed units for optimization of harmonious fitment and displaying performance of a layout; accepting the processed units and matching the processed units to the layout wherein the layout is selected from a repository of layout templates; integrating the processed units into a designated position of the layout; requesting the enrichment engine to further reformat the processed units in order to snug fit the processed units into the layout resulting a final ready layout; presenting the final ready layout.

In one embodiment, further comprising assigning a preference score of a selected layout to a heuristics database in order to recommend a preferred layout to a user.

In one embodiment, the final ready layout contains a rhythmic or polyrhythmic pattern.

In one embodiment, the content is comprised of texts, images, videos, and audio feeds.

In one embodiment, the content is dynamically aggregated from a content source comprising web pages, web feeds and social network platforms.

In one embodiment, the attribute is selected from a group consisted of number of words, font type, font size, image size, image resolution, image aspect ratio, image orientation, media clip type, video blocks, media clip size, media type, size of an object in an image, position of an object in an image, content of an objection in an image.

In one embodiment, the properties are metadata.

In one embodiment, the enrichment process is comprised of reformatting color of a text, reformatting style of a text, reformatting font of a text, reformatting size of a text, reformatting size of an image, reformatting resolution of an image, reformatting borders of an image, reformatting zoom of an image, reformatting resolution of a media clip, reformatting length of a media clip, reformatting size of a media clip.

In one embodiment, the properties and attributes of the processed unit are updated to be consistent with the enrichment process. In one embodiment, the metadata of the processed unit are updated consistent with the enrichment process.

In one embodiment, the layout engine uses an algorithm to match the processed unit to the layout wherein the layout is selected from a repository of layout templates. In one embodiment, the algorithm enables the final layout to contain a rhythmic or a polyrhythmic pattern. In one embodiment, the algorithm enables the final layout to contain a harmonious tiling pattern.

In one embodiment, the algorithm enables the final layout to contain a harmonious tiling pattern.

In one embodiment, the final ready layout is an arbitrary, well-formed, HTML file.

In one aspect of the invention, a computer-implemented system is disclosed, comprising: a processing engine comprising a content flattening engine, which in operation, accepts a plurality of content from a dynamically aggregated feed of content or from an user input; parses and dissects the content into units of text and or media file and recording a plurality of attributes and properties of the units; categorizes the units based on the attributes and the properties; a content enrichment engine, which in operation, enriches the units according to the attributes and the properties by reformatting and resizing the units into a plurality of processed units for optimization of harmonious fitment and displaying performance of a layout; a layout engine, which in operation, accepts the processed units and matching the processed units to the layout wherein the layout is selected from a repository of layout templates; a presentation engine, which in operation, integrates the processed units into a designated position of the layout; requests the enrichment engine to further reformat the processed units in order to snug fit the processed units into the layout resulting a final ready layout; presents the final ready layout; and a pre-computed lay out engine, which in operation filters the plurality of content and determines if the plurality of content can be processed via a shortened pathway.

In one embodiment, the shorten path way is comprised of one or more layout templates wherein the layout templates are comprised of rhythmic and polyrhythmic pattern for content arrangements.

In one embodiment, the pre-computed lay out engine further comprises a filtering module which in operation filters the plurality of content by assigning scores to the plurality of content based on pre-determined attributes for harmonious layout and assign at least some of the plurality of content to the shorten pathway without been processed by the processing engine.

In one embodiment, the pre-computed lay out engine further comprises a filtering module which in operation filters the plurality of content by assigning scores to the plurality of content based on pre-determined attributes for rhythmic and polyrhythmic content layout and assign at least some of the plurality of content to the shorten pathway without been processed by the processing engine.

In one embodiment, the pre-determined attributes are comprised of font attributes, color attributes, layout attributes, media type attributes, purpose attributes, brand attributes, personality attributes, voice attributes.

In another aspect of the invention, a method is disclosed comprising: filtering a plurality of content from a dynamically aggregated feed of content and analyzing the plurality of content for inherent rhythmic and polyrhythmic harmony; filtering out the plurality of content having high characteristic of inherent rhythmic and polyrhythmic harmony for shorten pathway processing; processing rest of the plurality of content lacking high characteristic of inherent rhythmic and polyrhythmic harmony by ; parsing and dissecting the content into units of text and or media file and recording a plurality of attributes and properties of the unit; categorizing the units based on the attributes and the properties; enriching the units according to the attributes and the properties by reformatting and resizing the units into a plurality of processed units for optimization of harmonious fitment and displaying performance of a layout; accepting the processed units and matching the processed units to the layout wherein the layout is selected from a repository of layout templates; integrating the processed units into a designated position of the layout; requesting the enrichment engine to further reformat the processed units in order to snug fit the processed units into the layout resulting a final ready layout; presenting the final ready layout.

In one embodiment, the shorten path way is comprised of one or more layout templates wherein the layout templates are comprised of rhythmic and polyrhythmic pattern for content arrangements.

In one embodiment, filtering the plurality of content is by the operation of assigning scores to the plurality of content based on pre-determined attributes for harmonious layout and assign at least some of the plurality of content to the shorten pathway without been processed by the processing engine. In one embodiment, the pre-determined attributes are comprised of font attributes, color attributes, layout attributes, media type attributes, purpose attributes, brand attributes, personality attributes, voice attributes.

In one aspect of the invention, a computer-implemented system is disclosed comprising: a content flattening engine, which in operation,
accepts a plurality of content from a dynamically aggregated feed of content or from an user input; parses and dissects the content into units of text and or media file and recording a plurality of attributes and properties of the units;
categorizes the units based on the attributes and the properties;
a content enrichment engine, which in operation,
enriches the units according to the attributes and the properties by reformatting and resizing the units into a plurality of processed units for optimization of harmonious fitment and displaying performance of a layout;
a layout engine, which in operation,
accepts the processed units and matching the processed units to the layout wherein the layout is selected from a repository of layout templates;
a presentation engine, which in operation,
integrates the processed units into a designated position of the layout;
requests the enrichment engine to further reformat the processed units in order to snug fit the processed units into the layout resulting one or more final ready layouts;
presents the one or more final ready layouts for the user to select;
a predicitive analysis engine wherein in operation the predicitive analysis engine compile the records of the selection of final ready layouts of the one or more user into a prediciative anaylsis database and use the database to yield individually relevant final ready layouts by altering the operation of the content flattening engine and saif content enrichment engine and the layout engine and the presentaton engine wherein the predicitive analysis engine utilizies sotchastic matrix to optimize its results.

In another aspect of the invention, a method comprising
accepting a plurality of content from dynamically aggregated feed of content or an user input; parsing and dissecting the content into units of text and or media file and recording a plurality of attributes and properties of the unit; categorizing the units based on the attributes and the properties; enriching the units according to the attributes and the properties by reformatting and resizing the units into a plurality of processed units for optimization of harmonious fitment and displaying performance of a layout;
accepting the processed units and matching the processed units to the layout wherein the layout is selected from a repository of layout templates;
integrating the processed units into a designated position of the layout;
requesting the enrichment engine to further reformat the processed units in order to snug fit the processed units into the layout resulting one or more final ready layouts;
presenting the one or more final ready layouts; compiling the records of the selection of the final ready layouts of the one or more user into a prediciative anaylsis database and use the database and using a sotchastic matrix to yield individually relevant final ready layouts by altering the operation of the content flattening engine and the content enrichment engine and the layout engine and the presentaton engine.

### BRIEF DESCRIPTIONS OF THE DRAWINGS

The accompanying drawings, which are incorporated herein and form a part of the specification, illustrate embodiments of the invention and, together with the description, further serve to explain the principles of the invention and to enable a person skilled in the relevant art to make and use the invention.

FIG. 1 illustrates an example of the current tiling and stacking method of displaying e-content.

FIG. 2 illustrates an example of the current invention's method of displaying e-content in a rhythmic manner.

FIG. 3 illustrates a high-level block diagram of a system environment for generating e-content using the current invention's polyrhythmic method of content presentation.

FIG. 4 illustrates a block diagram of the content processing system for generating e-content using the current invention's polyrhythmic method of content presentation.

FIG. 5 illustrates a block diagram of the content flattening engine of the current invention for generating e-content using the current invention's polyrhythmic method of content presentation.

FIG. 6 illustrates a block diagram of the enrichment engine of the current invention for generating e-content using the current invention's polyrhythmic method of content presentation.

FIG. 7 illustrates a block diagram of the layout engine of the current invention for generating e-content using the current invention's polyrhythmic method of content presentation.

FIG. 8 illustrates a block diagram of the presentation engine of the current invention for generating e-content using the current invention's polyrhythmic method of content presentation.

FIG. 9 illustrates an example of the current invention performing image feature detection to provide optimal aspect ratio, scale, and crop.

FIG. 10 illustrates an example of the image as in FIG. 9 that is over scaled using traditional method of fitting an image to a frame.

FIG. 11 illustrates an example of the image as in FIG. 9 that is over cropped using traditional method of fitting an image to a frame.

FIG. 12 illustrates an example of the image as in FIG. 9 that has been optimally scaled and cropped using the current invention of displaying e-content.

FIG. 13 illustrates an example of a screen shot of a video as presented using the current tiling and stacking method of displaying e-content.

FIG. 14 illustrates an example of a screen shot of the video as in FIG. 13 optimally scaled and cropped using the current invention of displaying e-content.

FIG. 15 illustrates an example of displaying multiple images and text as presented using the current tiling and stacking method of displaying e-content.

FIG. 16 illustrates an example of displaying the multiple images and texts as in FIG. 15 using the current invention of displaying e-content.

FIG. 17 (A&B) illustrates a preferred embodiment of the present flattening engine that receives and analyzes to be-published content.

FIG. 18 illustrates a block diagram of the present pre-computed layout module that receives and analyzes content for inherent harmony by using declarative, constrained-based language for composing polyrhythmic fitness functions over arbitrary data sets.

FIG. 19 illustrates an example of a pre-computed layout module assigning content, with inherent harmony, a pre-computed template thus preserving computational resources.

FIG. 20 illustrates a preferred embodiment of the present solution pathway module that receives and analyzes user configuration as well as GOM metadata from “Poly” to form a solution path to be utilized by the design system.

FIG. 21 illustrates an embodiment of a design system utilizing multiple solution pathway modules to produce a solution tree and consequently an HTML rendered page.

FIG. 22 illustrates a more mature embodiment of an evolved design engine including sub-engines for typography, color, decoration, animation, layout, and navigation for the purpose of rendering a magazine-like quality website.

FIG. 23 illustrates a preferred embodiment of a typography sub-engine within the larger design engine to generate typeface constraints on the final published website using the current inventions rhythmic and polyrhythmic methods combined with the current inventions predictive analytics technique to predict and produce the most appealing typography.

FIG. 24 illustrates an image of a flower processed by the present invention's color engine in order to produce a color scheme, which in turn produces multiple possible color combinations utilizing said color scheme.

FIG. 25 illustrates a preferred embodiment of a color sub-engine within the larger design engine to generate color constraints on the final published website using the current inventions rhythmic and polyrhythmic methods, combined with the current inventions predictive analytics techniques to predict and produce the most appealing color scheme.

FIG. 26 illustrates a high level example of a table driven event processing system utilizing multiple event processing tables, which is one of the current invention's methods of choice to accomplish predictive analytics. This figure and others to follow, are only meant to convey the most basic principle of table driven event processing, and does not represent the present invention's predictive analytic method in its entirety but merely a principle of computer science utilized by it to accomplish artificially intelligent webpage design.

FIG. 27, FIG. 28, and FIG. 29 each display example sections of an event-processing table defining a set of rules with corresponding events. These tables represent one set of rules as illustrated in FIG. 26. These figures are for illustrative purposes only and do not represent actual rules embodied by the present invention.

FIG. 30, FIG. 31, and FIG. 32 each display example sections of yet another event-processing table defining a set of rules. These figures are for illustrative purposes only and do not represent actual rules embodied by the present invention.

FIG. 33 illustrates the chronological flow of the method of table driven event processing utilized by finite state machines.

FIG. 34 illustrates a state diagram for a finite state machine embodied by an event-processing table with a plurality of processing tables and how each, pending certain events, may interact with all others. This figure is for illustrative purposes only and does not represent actual state diagrams of the present invention, which would be infinitely larger and more complex and furthermore impossible to represent in a single diagram.

FIG. 35 illustrates a sample Markov Chain. Chains such as this may be utilized by the present invention to achieve predictive analytics, thus enabling the present invention to solve problems with NP-hard solutions in little to no time.

FIG. 36 illustrates a simple Bayesian Network. Logic networks such as this may be utilized by the present invention to achieve predictive analytics, thus enabling the present invention to solve problems with NP-hard solutions in little to not time.

FIG. 37 illustrates three examples of a Markov Transition Matrix. The present invention's AI may utilize matrices, such as these, in order to adjust the outcome of Markov Chains, thereby allowing the present invention to guide future outcomes based on previous results.

FIG. 38 illustrates a simple predictive analytic method, analogous to those utilized by the present invention, to predict tourist destinations of Europeans who visit Northern California.

FIG. 39 illustrates an evolved predictive analytic method, analogous to those utilized by the present invention, to predict tourist destinations of Europeans who visit Northern California. However, the architecture has evolved autonomously and may now predict destinations of European tourists who are vegetarian.

FIG. 40 illustrates by example, raw movie tile data that may be consumed by the present inventions predictive analytic architecture for the purpose of predicting future movie titles.

FIG. 41 illustrates by example the predictive analytic method, analogous to those utilized by the present invention, according to the movie title data in FIG. 40 in order to produce movie titles with tier-seven complexity.

FIG. 42 illustrates by example, evolved or updated raw movie tile data that may be consumed by the present inventions predictive analytic architecture for the purpose of predicting future movie titles.

FIG. 43 illustrates by example an evolved predictive analytic method, analogous to those utilized by the present invention, according to the evolved or updated movie title data in FIG. 42 in order to produce movie titles with tier-seven complexity.

FIG. 44 illustrates a block diagram of one preferred method utilized by the present invention, which autonomously identifies breakpoints between various display types, and a corresponding template for each.

FIG. 45 illustrates the present inventions preferred method of determining breakpoints between display devices using a systematic autonomous process for the purpose of maintaining rhythmic and polyrhythmic patterns of resulting webpages.

### DETAILED DESCRIPTION OF THE INVENTION

The following detailed description refers to the accompanying drawings that illustrate certain embodiments consistent with this invention. Other embodiments are possible, and modifications can be made to the embodiments within the spirit and scope of the invention. Therefore, the detailed description is not meant to limit the invention; rather, it is meant to illustrate by example. It should be noted that references to “an” or “one” or “some” embodiment(s) in this disclosure are not necessarily to the same embodiment, and such references mean at least one.

A new approach is proposed that contemplates systems and methods to provide an automatic, yet customizable to individual users and audiences' taste, publishing e-content, which comprises texts, images, and media clips, in a high quality, magazine-like manner. The approach addresses the issue of design and technology know-how through separating or decoupling of the design aspect and the technology aspect. Specifically, the approach automatically provides the most optimum layout or presentation to be selected over time based on heuristics, which relies on metadata.

Generally, one of the first rhythms that viewers confront in a design is the rhythm of the format. The format has a dominant and a subordinate rhythm. The dominant rhythm is determined by the longest axis. Another rhythm is the rhythm of words and groups of words wherein the word shapes are adaptable and work well with each other. They also need to be balance and have clarity of each part within a composition. There may also be other types of rhythms and these one or more rhythms, or polyrhythms, should compliment one another and not draw undue attention to itself or others. Therefore, it is important to understand the content available to be composed in the design. As such, a content flattening component, or a content flattening engine, is necessary to first analyze and structure the contents.

In one embodiment, a content flattening engine is provided to receive and analyze the to be-published content from a variety of sources. Each content item comprises one or more units. Each unit has a unit type, such as text, image, or video. The units included in each received item are identified by the content flattening engine and stored with the item. Then, this engine dissects the content into units of texts, images, and/or media clips while keeping notes of their properties, such as the number of words, font type, image size and resolution, image aspect ratio, image orientation (i.e., landscape or portrait), media clip size and type, video blocks, etc. This property information can be very detailed and sophisticated, and can include information such as the size and position of objects in an image, e.g., persons' faces, objects, background, etc.

This engine employs a plurality of techniques, including parsing the incoming content stream, in order to categorize the units based on their properties. For example, well-known HTML and/or XML tags are detected and parsed. These tags are metadata that are an important part of the collected property information that are later used in selecting templates.

Besides providing intelligent information about the content elements, they also provides the structure of the content; in other words, information about how elements relate to one another. A plurality of algorithms for analyzing binary streams of texts, images, and videos are employed, and the objects' properties are collected. The collected property information, or metadata, is fed into subsequent engines to prepare for an optimal layout of the content. The content flattening component allows the contents to be sorted and structured such that the rhythm or rhythms of the design based on the contents can be determined. However, when the contents in their native state cannot provide a natural rhythm, the contents can be altered or modify in order to improve the overall flow of the design, and this is done through the enrichment component.

In one embodiment, an enrichment engine is provided to enrich the elements of the content. The incoming content is a binary stream that is accompanied by the metadata, which provides the structure of the content and each elements' relevant properties. For example texts are reformatted as to font, color, styles, and/or reflowed to fit harmoniously with the whole layout. Images are analyzed, cropped or resized, and/or modified resolution-wise to increase its own aesthetic and that of the whole layout. Media clips are spliced, cut, downscaled, etc. to fit the other content elements and boost the displaying performance of the web page.

While enriching the content, the changes in the properties of the content elements are tracked and the metadata is updated to reflect the changes. The output of this engine and its method is a desired content stream, and it is the metadata the contents that enable the method and system to be able to generate a high quality, magazine-like layout. Once the contents have been enriched, they need to be arranged in such a way as to provide a rhythmic or poly rhythmic layout, and this is done through the layout component.

In one embodiment, a layout engine is provided to pair the incoming content with an optimal layout in a large repository of layout templates. More particularly, the layout engine uses content's metadata to pair the incoming content with an optimal layout. Specifically, the metadata, which are composed by the flattening engines, sets the criteria or parameters for the search. Then, a pathfinding algorithm is employed to efficiently search through the template repository for an optimal layout that best represents the content. The pathfinding algorithm uses the criteria or parameter set forth by the metadata in order to efficiently search through the template repository for the optimal layout.

One way to improve the efficiency of the search is to perform the search with the use of heuristics, which are experience-based techniques for problem solving, learning, and discovery. In more precise terms, heuristics are strategies using readily accessible and applicable information to control problem solving. In this case, the heuristics employed are based on the knowledge of templates in the repository and/or the users' predefined rules. Notably, this layout engine allows and works best with specific rules.

Furthermore, when the search result is a set or range, the result is presented to the user for whom to pick the favorite template according to the user's taste, and personal and professional experience with the content. This engine would remember the user's selection, and assigns it a higher preference score. Overtime, this layout engine builds up a weighted heuristic engine capable of automatically selecting an optimal layout with preference to the users' taste for a given content.

In addition to a good weighted heuristic engine, a quality large repository of layout templates makes up the quality of the present publishing system. Clearly, the larger repository of different layout templates is, the more quality the outcome of the present publishing system. The different layout templates could accommodate any possible content there is.

The repository of layout templates is also an innovative way to incorporate custom, taste preference design elements into an automate publishing system. Using the present system, web publishers and designers are free to focus on the design aspect of web publishing without worrying about how to fit their designs to the web technologies. In one embodiment, a user-friendly interface is provided to aid web publishers and designers in designing layout templates and saving them to the repository.

In another embodiment, instead of approaching the repository with a one-dimensional approach, the system can search through the repository via artificial intelligence engine. More specifically, the current approach to the search of repository requires assigning various values to criteria, and the system selects the best templates base on the criteria with the highest values. This process is slow, requires large amount of interaction, and is resource intensive. The alternative is to use artificial intelligence (AI) engine that labels the decision tree to discern the most likely to be picked layout through predictive behavior prediction or predictive analytic. For example, instead of using nodes with assigned values to make decisions, the AI engine can generate sets of rules depending on the user input to select the most likely layout. In other words, the AI engine does not need to assign and calculate each node value at every step. Instead, the AI engine is able to use the given criteria and, based on past user behavior, predicts and selects the best rules. The AI engine, then, make subsequent decisions base on those prediction rules to determine the best layout.

This friendly interface also aids users in managing the layout repository and categorizing the layout templates. Based on certain predefined criteria, similar templates are put in a category. It is appreciated that a template could belong to more than one category. The layout engine in its search for an optimal layout would use the category properties or metadata. Furthermore, layout templates within a category are often compared during the searching. Clearly, the more categories and detailed metadata are, the better quality the outcome layout is for a given input content.

Since the present invention decouples the design and technology aspect of web publishing, it opens up a new opportunity for a marketplace of third party designers' layout templates. The marketplace would provide incentives for ever better layouts and layout repositories, and drives down the cost of creating the layout templates. This in turn would allow web publishers to focus on the content.

Once the layout component pairs the incoming contents with the optimal template, the content and the template needs to interact in such a way as to make the content flow to provide a rhythmic or polyrhythmic pattern to hold the design together, and the presentation component allows the content and the template to interact and compose a rhythmic or polyrhythmic design.

In another embodiment, a presentation engine is provided to receive the input content and the selected template. This engine places the content elements in the designated positions of the selected layout template, relying on the metadata composed by previous engines. The enrichment engine may be called upon to further modify the content to “snug” fit the content elements to the final layout template.

Once the content elements are fitted in their positions on the layout, the whole web page is presented to the users for a final approval. It is appreciated that as the template repository grows larger, there will be more than one template to be a fit for the given content. The preview would become a chance for the users to pick the best presentation for a final approval. It is also appreciated that the users could translate their final selection criteria into rules that could be added to the heuristic engine, and used by the layout engine and its search engine to automate the selection process. The final presentation is a rhythmic or polyrhythmic design wherein the contents all flow together harmoniously.

### DETAILED DESCRIPTIONS OF THE DRAWINGS

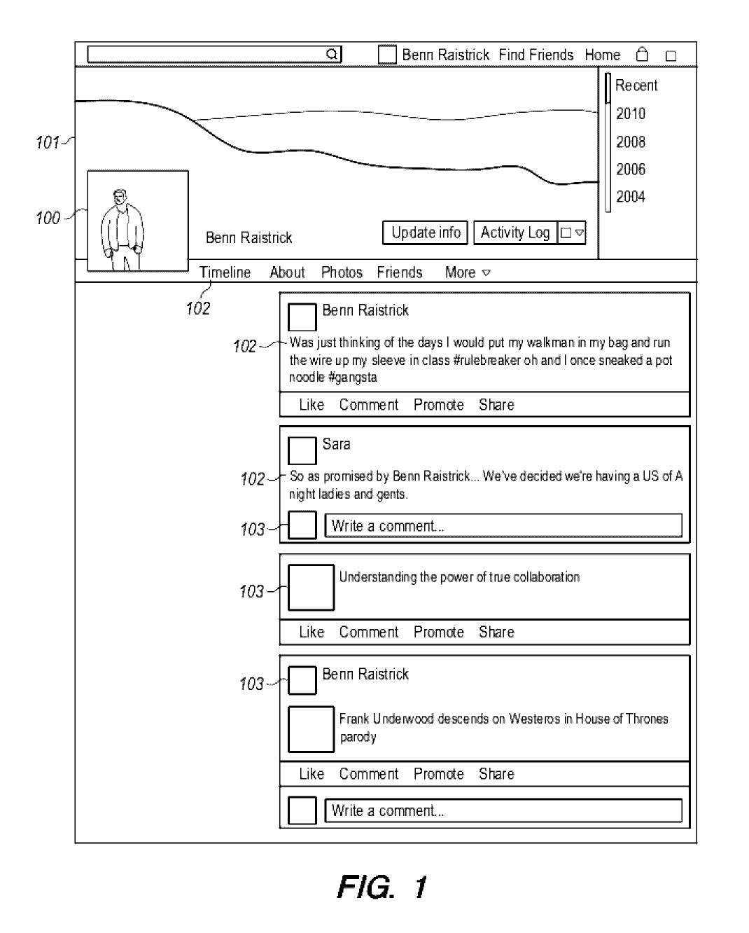

FIG. 1 illustrates the current stacking layout of a web page. As it is shown, there are a variety of issues and problems that needs to be addressed. First, the owner's photo 100 is not clear because it is a distance shot. Second, the photo background 101 is unnecessary, and it draws attention away from the main focus of the photo 100. Furthermore, all the texts 102 on the blog have same font style and font size; therefore, the audience does not know what message is important because nothing stands out in particular to the audience. Moreover, different size thumbnail images 103 are randomly placed, resulting in disorganization to the point that they make the blog look unpleasing to the eye.

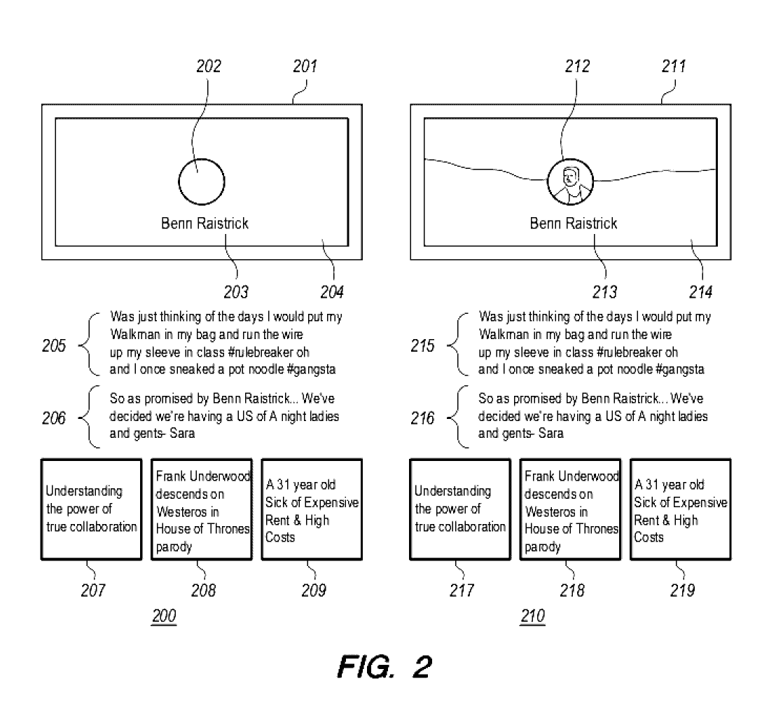

Referring to FIG. 2, in one embodiment, vertical and horizontal rhythmic designs are employed to produce a very appealing blog. The layout template 200 on the left employs many design elements. Vertically, the layout has a header block 201 where a circular image container 202 and text container 203 are placed inside another larger background image container 204. The image container 202 is for the head shot of the owner; text container 203 for his name; and background image 204 for his personality, mood, and/or inspiration. Below the header block is the quote of the day or the owner's thought of the day block 205. Large font makes the quote in important content element of the blog. Below quote is the miscellaneous message/announcement block 206, whose font is much smaller than the text above, and this visually informs the audience of an unimportant message. Finally, below the miscellaneous message block, three equal size tiles 207, 208, 209 are placed horizontally, and used to show the owner's favorite news articles. A horizontal rhythm is employed here where an image from each article is used for the background of the tiles, and each article's title is placed on top the image in the foreground, and has white font.

Still referring to FIG. 2, on the right side, an example of a final presentation of the blog layout 210 is presented. In the header block 211, he owner's headshot is cropped to fit the small circular image container 212. The text container 213 displays the owner's name, and a background image 214 displays an image for owner's personality, mood, and/or inspiration. The quote of the day block 215 is prominent displayed on the blog. Below the quote is the miscellaneous message/announcement block 216 that displays a message from the owner's friend. The white article titles 217, 218, 219 contrast well against the background image. As a whole, the blog 210 is pleasing to the eye.

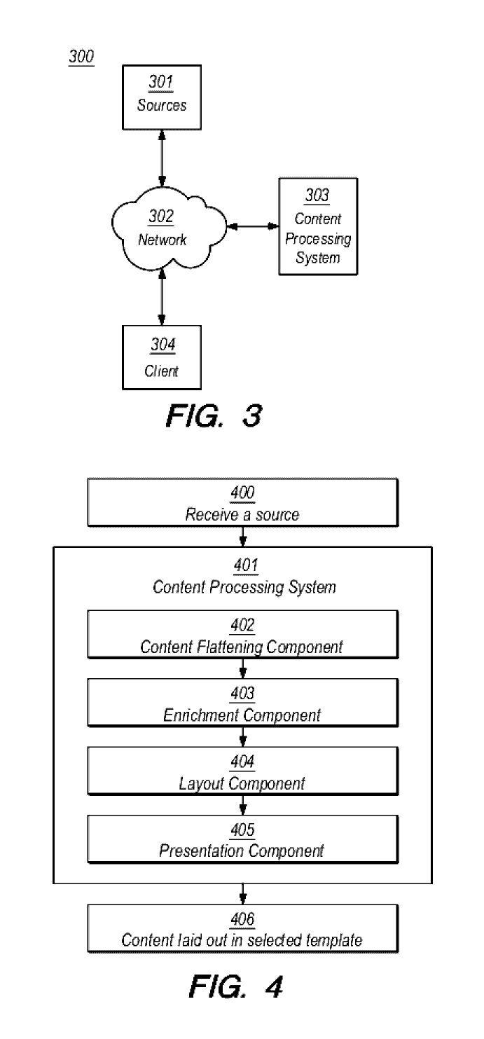

Referring to FIG. 3, the environment 300 includes content sources 301, a client 304, and a content processing system 303 in communication over a network 302. The sources 301 includes various types of content such as text, images, videos, or audio on web pages, web feeds, social networks, or other distribution platforms. The content may also include content provided by publishers, such as stories about news events, product information, entertainment, or educational material. Content may also include user-generated content such as blogs, tweets, shared images, video or audio, and social networking posts and status updates. For convenience, content from a source, regardless of its composition, may be referred to herein as a “content unit” or simply “content.”

The content processing system 303 receives content items from the sources 301, processes the content items to build pages, and serves the pages to a client 304. On the other hand, a client 304 can be any computing device equipped with a browser for accessing web pages and a display for viewing them, such as a personal computer, a tablet computer, or a mobile device. A client 304 receives pages from the content processing system 303 and displays them to a user.

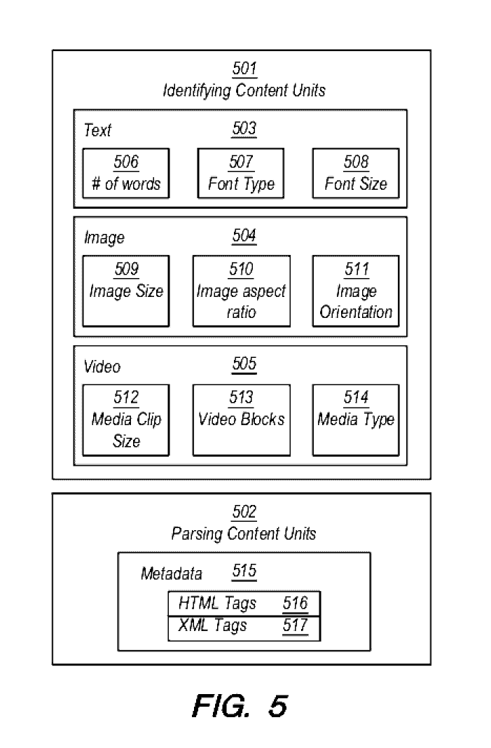

Referring to FIG. 4, a source 400 is sent to the content processing system 401. The content processing system 401 comprises a content flattening engine 402, an enrichment engine 403, a layout engine 404, and a presentation engine 405.

The content flattening engine 402 is provided to receive and analyze the to be-published content from a variety of sources. Besides providing intelligent information about the content elements, they also provides the structure of the content; in other words, information about how elements relate to one another.

The enrichment engine 403 is provided to enrich the elements of the content. While enriching the content, the changes in the properties of the content elements are tracked and the metadata is updated to reflect the changes. The output of this engine and its method is a desired content stream, and it is the metadata the contents that enable the method and system to be able to generate a high quality, magazine-like layout.

The layout engine 404 is provided to pair the incoming content with an optimal layout in a large repository of layout templates. More particularly, the layout engine uses content's metadata to pair the incoming content with an optimal layout.

The presentation engine 405 is provided to receive the input content and the selected template. This engine places the content elements in the designated positions of the selected layout template, relying on the metadata composed by previous engines.

Once the content elements are fitted in their positions the layout, the whole web page is presented to the users for a final approval. The content is laid out in the selected template and the resulting e-content 406 is sent to the client.

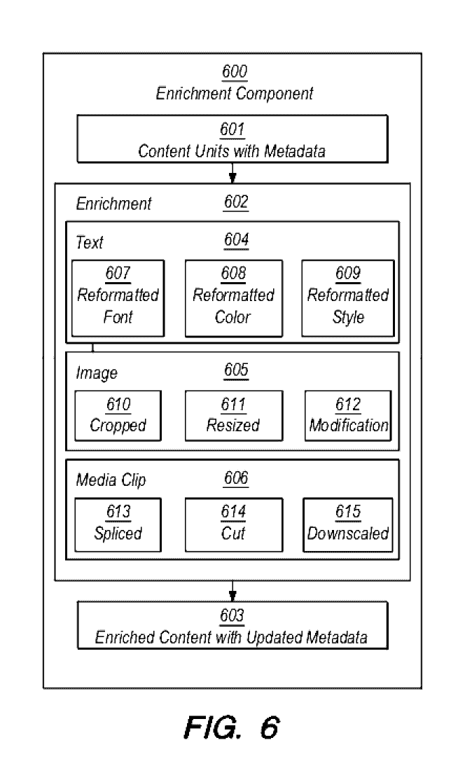

Referring to FIG. 5, the content flattening engine 500 processes the contents in two separate steps. The content flattening engine 500 identifies the content units 501 and dissects the content into units of texts 503, images 504, and/or media clips 505 while keeping notes of their properties, such as the number of words 506, font type 507, font size 508 image size and resolution 509, image aspect ratio 510, image orientation 511 (i.e., landscape or portrait), media clip type 512, video blocks 513, media clip size 513, media type 514, size and position of objects in an image, e.g., persons' faces, objects, background, etc.

Then, the content flattening engine 500 parses the content units 502 in order to categorize the units based on their properties such as metadata 515. For example, well known HTML tag 516 and XML tags 517 are detected and parsed. These tags are metadata 515 that are an important part of the collected property information that are later used in selecting templates.

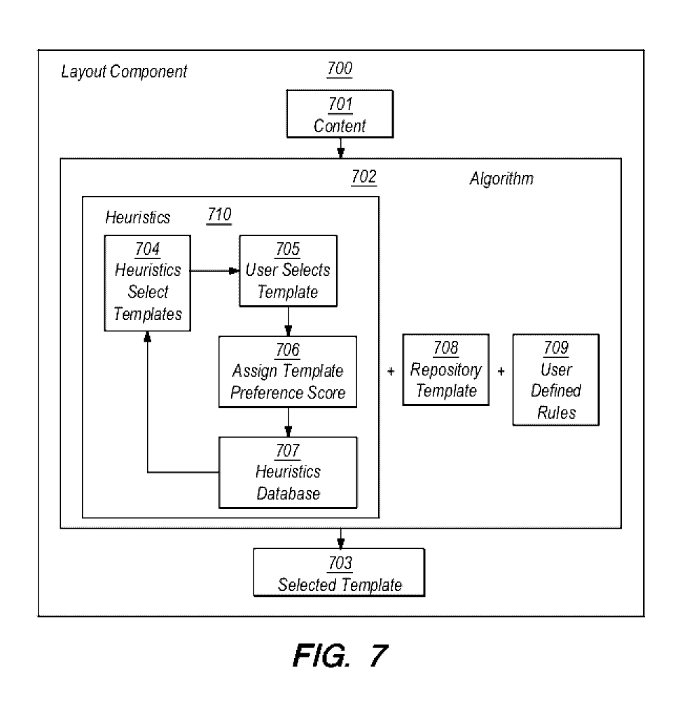

Referring to FIG. 6, the enrichment engine 600 enriches the elements of the content. The incoming content is a binary stream, and each binary stream or content units, is accompanied by the metadata 601, which provides the structure of the content and each elements' relevant properties.

The content unit with metadata 601 is enriched via the enrichment process 602 according to its metadata properties. For example, texts 604 are reformatted as to font 607, color 608, styles 609, and/or reflowed to fit harmoniously with the whole layout. Images 605 are analyzed, cropped 610 or resized 611, and/or modified resolution-wise 612 to increase its own aesthetic and that of the whole layout. Media clips 606 are spliced 613, cut 614, down-scaled 614, etc. to fit the other content elements and boost the displaying performance of the web page.

While enriching the content, the changes in the properties of the content elements are tracked and the metadata is updated 603 to reflect the changes. The output of this engine and its method is a desired content stream, and it is the metadata the contents that enable the method and system to be able to generate a high quality, magazine-like layout.

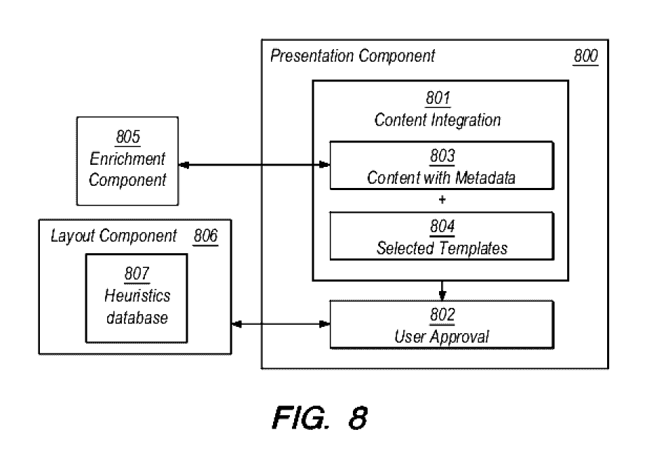

Referring to FIG. 7, the layout engine 700 provides to pair the incoming content 701 through an algorithm 702 with an optimal layout 703 in a large repository of layout templates.

Specifically, the algorithm 702 employs a heuristics 710 that select several templates 704 from which the user can further select the template 705. Then, the user selected template will be assigned a preference score 706 that is stored in the heuristics database 707 which will be used by the heuristics to improve its selection of templates 704. The Heuristics 710 in connection with the repository template 708 and the user defined rules 709 result in the optimal layout for the content 701 using the selected template 703.

Notably, a quality large repository 708 of layout templates makes up the quality of the present publishing system. Clearly, the larger repository of different layout templates is, the more quality the outcome of the present publishing system. The different layout templates could accommodate any possible content there is.

Furthermore, the user can define rules 709 to guide the selection of templates and allows the user to manage the layout templates through categories. The layout engine in its search for an optimal layout would use the category properties or metadata. Moreover, layout templates within a category are often compared during the searching. As such, the more categories and detailed metadata are, the better quality the outcome layout is for a given input content.

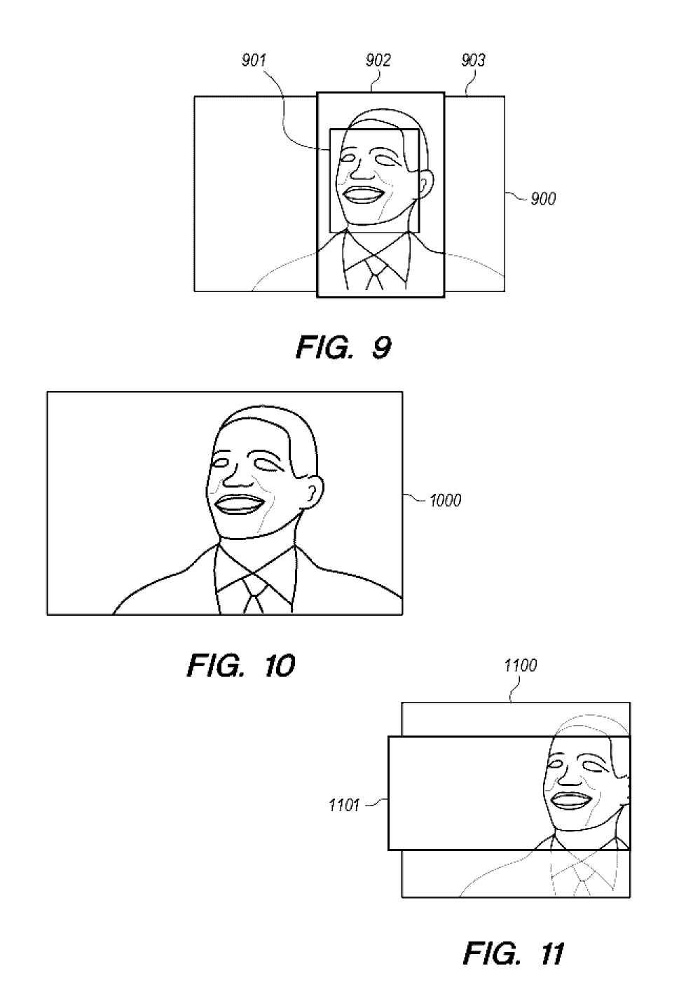

Referring to FIG. 8, the presentation engine 800 comprises a content integration step 801 and a user approval step 802. Specifically, the content integration 801 places the content 803 in the designated positions of the selected layout template 804, relying on the metadata composed by previous engines. The enrichment engine 805 may be called upon to further modify the content to “snug” fit the content elements to the final layout template.

Once the content elements are fitted in their positions on the layout, the whole web page is presented to the users for a final approval 802. Furthermore, as the template repository grows larger, the layout engine 806 will be able to provide increasing more templates for a given content. The preview would become a chance for the users to pick the best presentation for a final approval 802. Moreover, the users could translate their final selection criteria into rules that could be added to the heuristic engine 807, and used by the layout engine 806 and its search engine to automate the selection process.

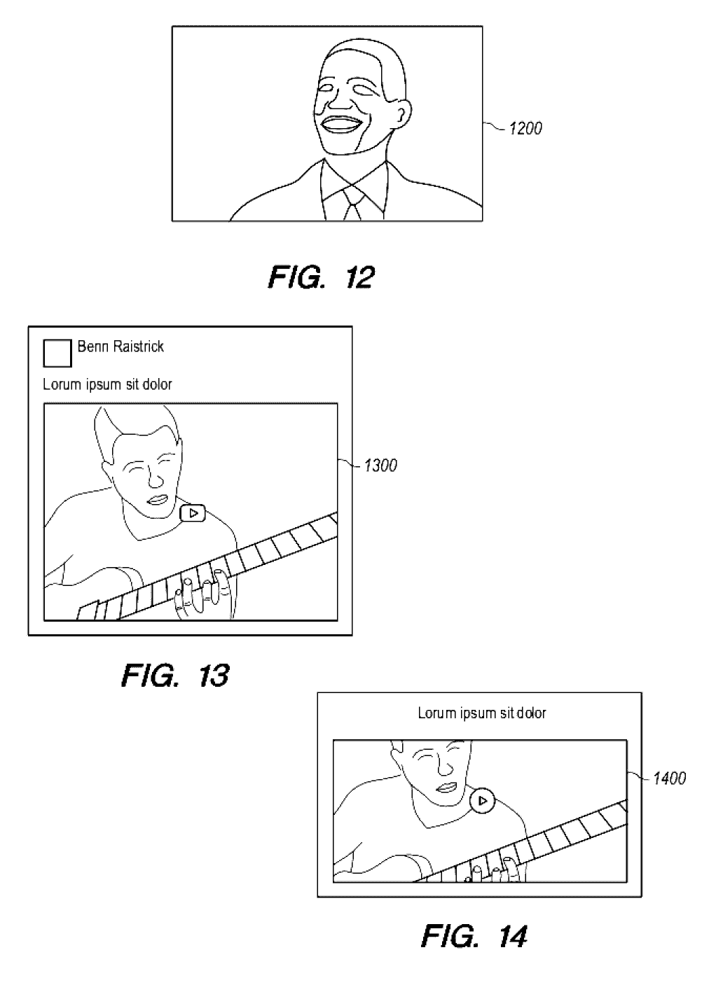

Referring to FIG. 9, this is an example of the current invention performing image feature detection to provide optimal aspect ratio, scale, and crop. Specifically, the image 900 is a photo of a person with a background. The current invention performs detection of important image features, such as faces 901, foreground subjects 902, and backgrounds 903. This allows the current invention to calculate and perform the optimal scaling and cropping of the image 900 in order for it to optimally fit the frames with minimal crop and up-sampled scaling.

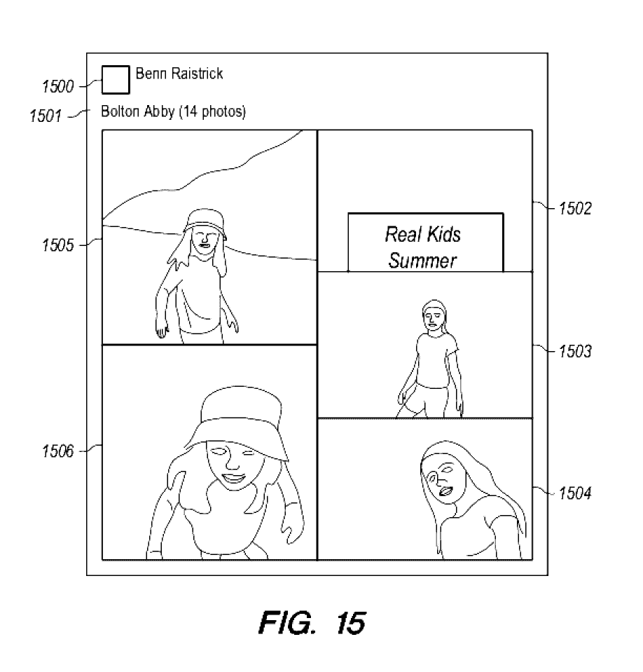

Referring to FIG. 10, this is an example of the image as in FIG. 9 that is over scaled using traditional method of fitting an image to a frame. The image 1000 is over scaled, and, as a result, becomes distorted and pixelated.

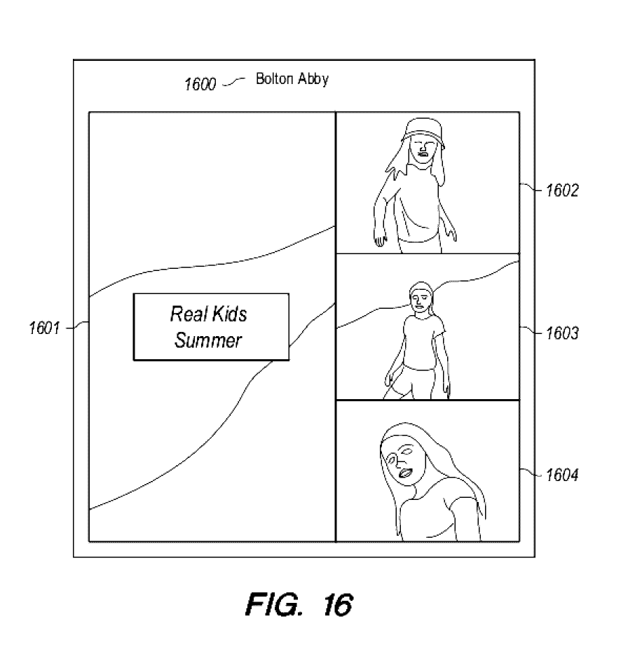

Similarly, FIG. 11, this is an example of the image as in FIG. 9 that is over cropped using traditional method of fitting an image to a frame. The image 1100 is over cropped such that the resulting image 1101 has the cut of part of a person's face and the face is too much to the right causing an imbalance.

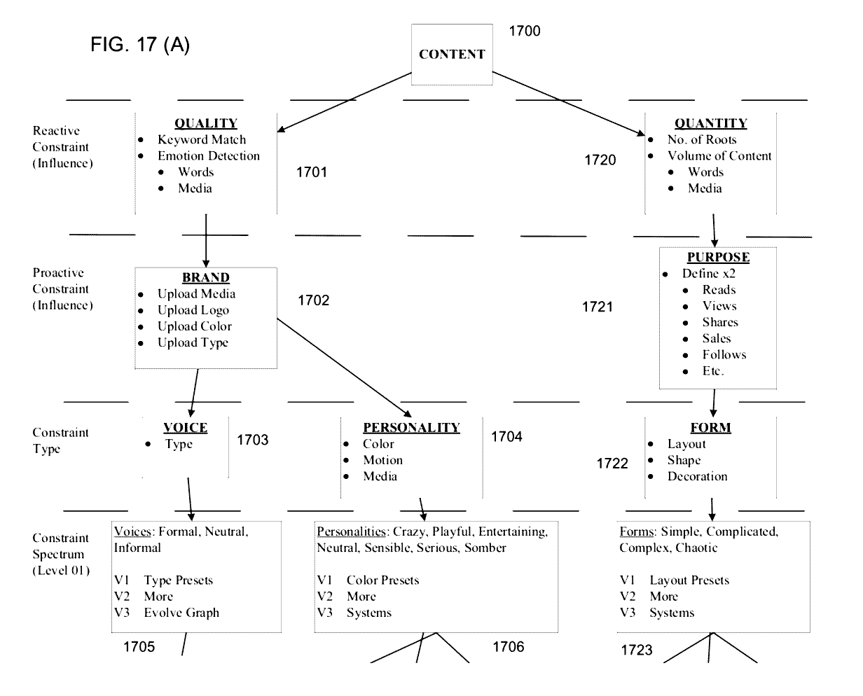

Referring to FIG. 12, on the other hand, this is an example of the image as in FIG. 9 that has been optimally scaled and cropped using the current invention of displaying e-content. The image 1200 has been processed using an image feature detection that has determined the face, the foreground, and the background of the image. Then, based on those features, the image 1200 has been optimally and minimally cropped and scaled to allow it to fit the frame perfectly.

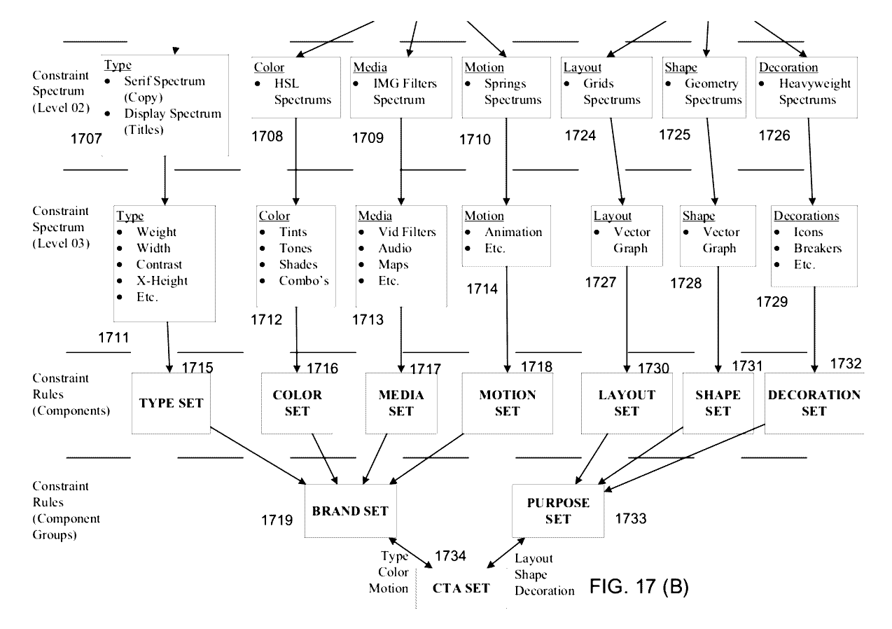

Referring to FIG. 13, this is an example of a screen shot of a video as presented using the current tiling and stacking method of displaying e-content. The video 1300 is a square frame that contains a screen shot of the video.

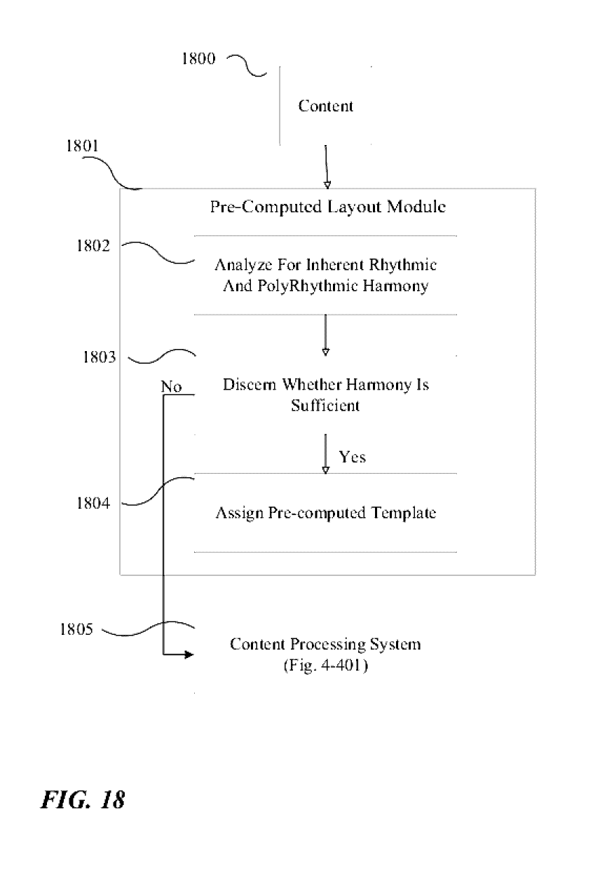

Referring to FIG. 14, however, this is an example of a screen shot of the video as in FIG. 13 optimally scaled and cropped using the current invention of displaying e-content. As can be seen, the video screen shot 1400 is scaled up to be larger and it is also cropped at the top and bottom. The resulting video screen shot 1400 is more artistic and draws more attention to the video itself.

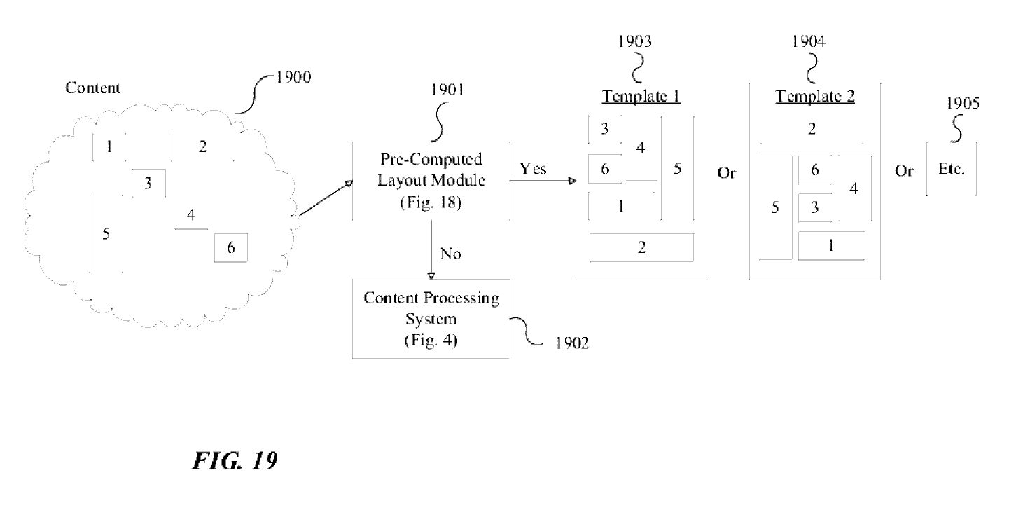

Referring to FIG. 15, this is an example of displaying multiple images and text as presented using the current tiling and stacking method of displaying e-content. The owner 1500 has published a series of photos of another person 1501. A cover consisting of 5 photos displays the series of photos that each fit a frame to form a larger square frame. Specifically the right hand column consists of a title photo 1502 on to top with two photos 1503, 1504 beneath it. The left hand column consists of two larger photos 1505, 1506. The current tiling and stacking method of displaying e-content does not take into account the face and features of the photos and therefore cropped and scaled the photos with the purpose of fitting them into a predetermined frame. Therefore, photos may be cropped in an undesired manner, such as the title photo 1502 where the words are partially cut off.

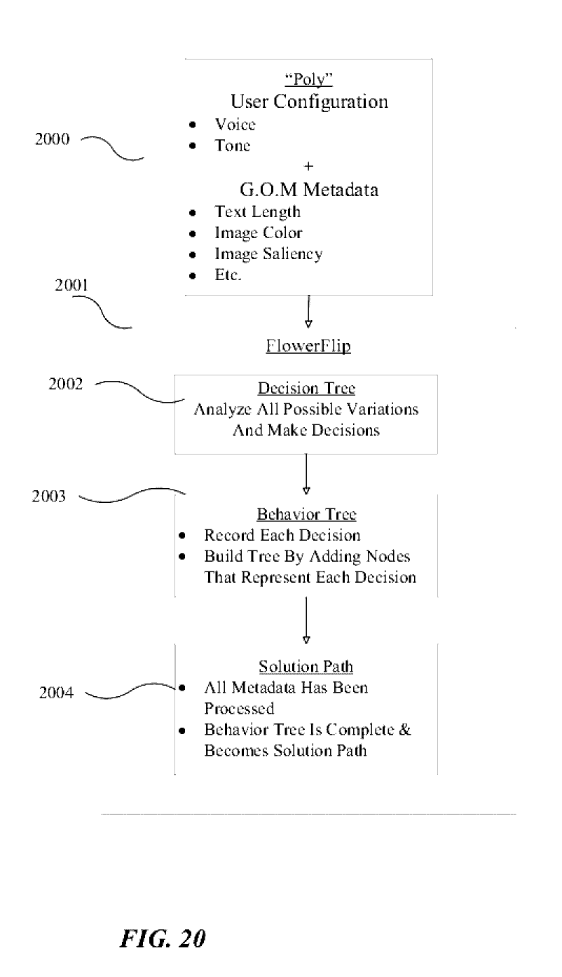

Referring to FIG. 16, this is an example of displaying the multiple images and texts as in FIG. 15 using the method of the current invention of displaying e-content. The method of the current invention provides a large font to identify the subject or person 1600 whose photo was being taken. Then, the current invention performs a detection of important features, such as faces, foreground subjects, and background objects. Then, it determines the title photo 1601 should occupy a larger space on the left hand column, and it selects 3 photos 1602, 1603, 1604 where the subject 1600 is closer in the photo via face and subject detection feature. The 3 photos 1602, 1603 and 1604 are optimally cropped and scaled to fit into the frame.

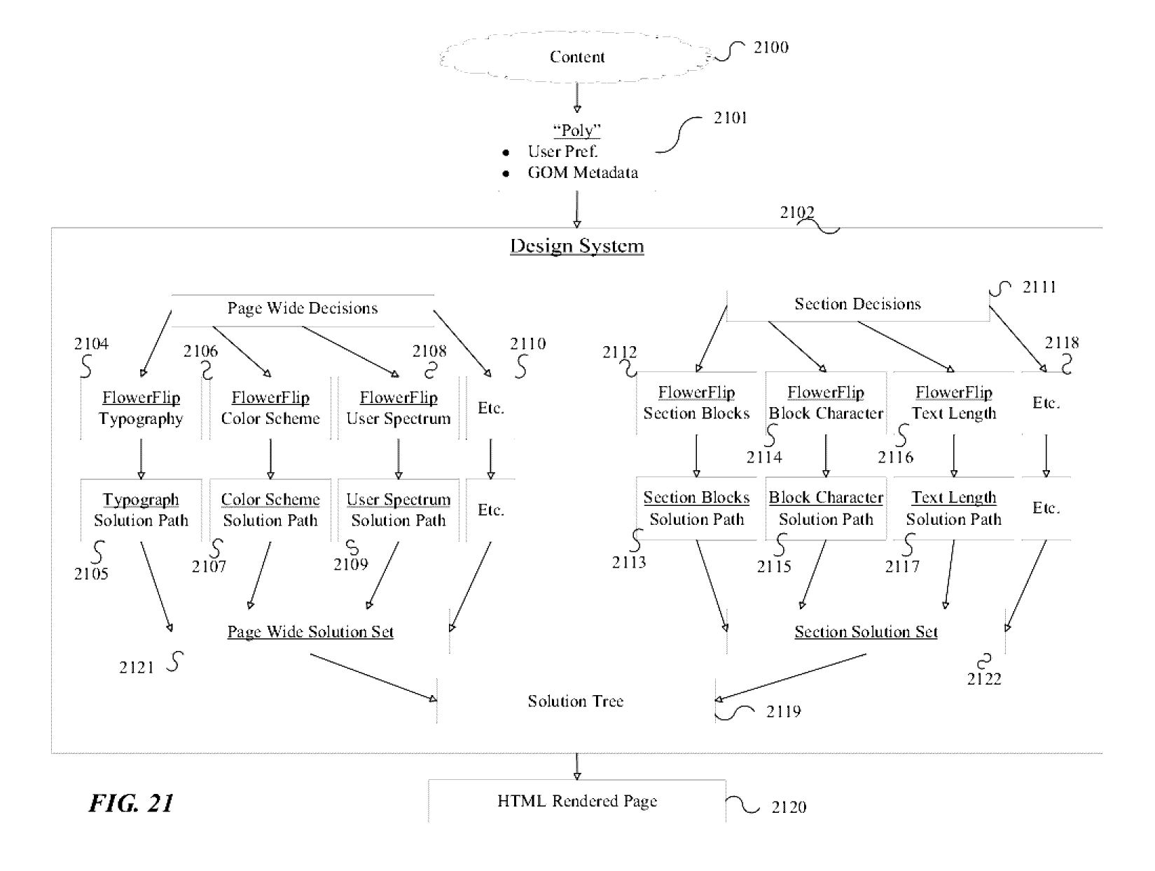

Referring to FIG. 17 (A&B), this illustrates a preferred embodiment of the present flattening engine that receives and analyzes content 1700 to be published. This engine behaves as a synthesis module comprised of two sub-modules to discern both quality 1701 and quantity 1720 of incoming content 1700 to be published. The quality module 1701 is designed to act as a reactive constraint that will influence the finalized content to be published. The module synthesizes the emotional or expressive substance of the incoming content 1700 by keyword matching and by detecting emotional substance contained in the words and media of the content 1700. The resulting data from the quality module 1701 is then passed to the brand module 1702.

The brand module 1702 influences the final published product by allowing the user to add proactive constraints if they so desire. This module allows a user to upload personal media and logos that they desire the published product to mimic. From these the module extracts color and type font using two sub-modules voice 1703 and personality 1704 to influence the final published product.

As to the first sub-module, voice 1703, this module analyzes text contained in the user-uploaded brand and extracts the uploaded type or font to provide a constraint to be incorporated in the final published product. Once extracted, the data is subjected to three levels of constraint spectrums including 1705, 1707, and 1711. The first 1705 is dictated by user input based on a sliding scale. The user may specify a preference for formal, neutral, or informal voice regarding the font. Based on this input, the sub-module adds a constraint to the data regarding which fonts may be used. The second 1707 similarly apply constraints to the Serif Spectrum and Display Spectrums. The third and final constraint spectrum for type 1711 similarly adds constraints to the weight, width, contrast, X-height, etc. to be used in the font. The result of these three is a Type Set 1715 of constraint rules to dictate the appearance of all text in the final published product and becomes one of four components of the Brand Set 1719.

As to the second sub-module, personality 1704, this module discerns the colors, type of motion, and media contained in the user-uploaded brand and extracts this information as constraints on personality. The personality sub-module 1704 is comprised of three levels of constraint spectrums. The second and third level spectrums each have separate constraints for color, media, and motion. The first 1706 is dictated by user input based on a sliding scale. The user may specify a preference for crazy, playful, entertaining, neutral, sensible, serious, or somber. Based on this input, the sub-module adds a second level of constraints to the data regarding what color, media, and motion specifications may be used. Accordingly, color 1708 is determined using HSL spectrum that best reflects user input in 1706. An HSL color spectrum consists of color, saturation, hue, and lightness. Media 1709 constraints are applied using a spectrum of IMG Filters that best reflects user input in 1706. Motion 1710 constraints are also applied using a spectrum of spring motions that best reflects user input in 1706. A third level of constraint is then added for color, media, and motion. Regarding color 1712, constraints are set forth for tint, tone, shade, etc. and other various combinations. The result is a Color Set 1716 of constraint rules to dictate the appearance of all color in the final published product and becomes one of four components of the Brand Set 1719. For media 1713, constraints are set forth for video filters, audio, maps, etc. The result is a Media Set 1717 of constraint rules to dictate the appearance of all media in the final published product and becomes one of four components of the Brand Set 1719. For motion 1714, constraints are set forth for animation etc. of the future published content. The result is a Motion Set 1717 of constraint rules to dictate the appearance of motion in the final published product and becomes one of four components of the Brand Set 1719. This concludes the description of the quality module 1701.

The quantity module 1720 is designed as a reactive constraint that will influence the finalized content to be published. The module discerns the number of roots in the content 1700. It also discerns the volume of the content 1700 by detecting words and media contained therein. The resulting data from the quantity module 1720 is then passed to the purpose module 1702. The purpose module 1721 influences the final published product by allowing the user to add proactive constraints. This module allows a user to select two goals or purposes they wish the website to accomplish. Pending their selections, this module then instructs the form sub-module 1722 to apply constraints most consistent with those purposes. Accordingly, the form sub-module 1722 then applies constraints to layout, shape, and decoration regarding the content 1700 to be published.

The data is then subjected to three levels of constraint spectrums. The second and third levels are composed of three individual constraint spectrums for layout, shape, and decoration. The first level constraint spectrum 1723 is dictated by user input based on a sliding scale. The user may specify a form preference of simple, complicated, complex, or chaotic. Based on this input, the sub-module adds a second level of constraints to the data regarding what specifications for layout 1724, shape 1725, and decoration 1726 may be used. Accordingly, layout 1724 is constrained using grid spectrums that best reflect user input in 1723. Shape 1725 constraints are applied using geometry spectrums that best reflect user input in 1723. Decoration 1726 constraints are also applied using heavyweight spectrums that best reflect user input in 1723. A third level of constraint is then added for layout 1727, shape 1728, and decorations 1729. Regarding layout 1727, constraints are set forth regarding vector graphics. Vector graphics is a method of electronically coding graphic images so they are represented in lines rather than fixed bitmaps, allowing an image, as on a computer screen, to be rotated or proportionately scaled. The result is a Layout Set 1730 of constraint rules to dictate the layout of the final published product and becomes one of three components of the Purpose Set 1733. For shape 1728, constraints are also set forth regarding vector graphics. The result is a Shape Set 1731 of constraint rules to dictate the shape of the final published product and becomes one of three components of the Purpose Set 1733. For decoration 1732, constraints are also set forth regarding icons, breakers, etc. The result is a Decoration Set 1731 of constraint rules to dictate the decoration of the final published product and becomes one of three components of the Purpose Set 1733. This concludes the description of the quantity module 1720.

The Brand Set 1719 is comprised of the Type Set 1715, Color Set 1716, Media Set 1717, and Motion Set 1718. The Purpose Set 1733 is comprised of the Layout Set 1730, Shape Set 1731, and Decoration Set 1732. Together the Brand Set 1719 and Purpose Set 1733 constitute the finalized CTA Set 1734 of metadata for the content 1700 that is to be published.

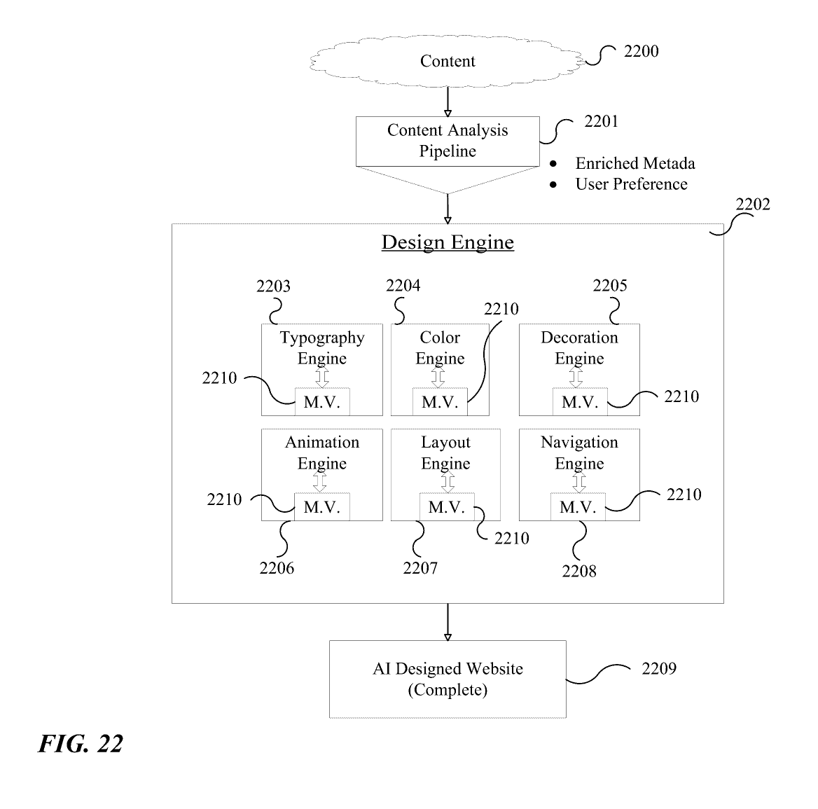

Referring to FIG. 18, this block diagram illustrates a present pre-computed layout module 1801 that receives content 1800 and analyzes it for inherent harmony 1802. Evaluating harmony requires evaluating how well a collection of objects or elements conform to repetitive patterns. Patterns may be rhythmic or polyrhythmic in nature. A rhythmic pattern is a straightforward manifestation of the same pattern in multiple elements. A polyrhythmic pattern is the simultaneous use of two or more conflicting rhythms, which are not readily perceived as deriving from one another, or as straightforward manifestation of the same rhythmic pattern. By combining many such patterns, or harmonies, the harmonic quality of arbitrary metadata may be discerned. To discern the data for patterns, or harmony, a track method monitors for “hits” and “misses” of a particular pattern. Track methods do not score hits and misses but merely compute them. Different track scoring functions subsequently score the results. Assuming a sufficient overall harmony score, the content is then assigned a pre-computed layout, thereby conserving computational resources that would otherwise be consumed by the content processing engine 1805.

The pre-computed layout module 1801 first receives the content to be published 1800. The content is then analyzed for inherent rhythmic and polyrhythmic harmony and is assigned a score 1802. Harmony elements that may be analyzed may include but are not limited to color schemes, color contrast, item size, item shape, media content, media length, text length, text font, text size, etc. By contrasting each element against all others, a harmony score is assigned to each element. This score represents how well that particular element compliments or detracts from all others as a whole. Each individual score is then compiled into an overall harmony score. Next, the module discerns whether the overall harmony score is sufficient enough to be assigned a pre-computed template 1803. If inherent harmony is high, a template is assigned and published 1804 saving significant computational resources. If not so, the content is delivered to the content processing engine (FIG. 4) 1805 for further flattening, enrichment, and subsequent publishing.

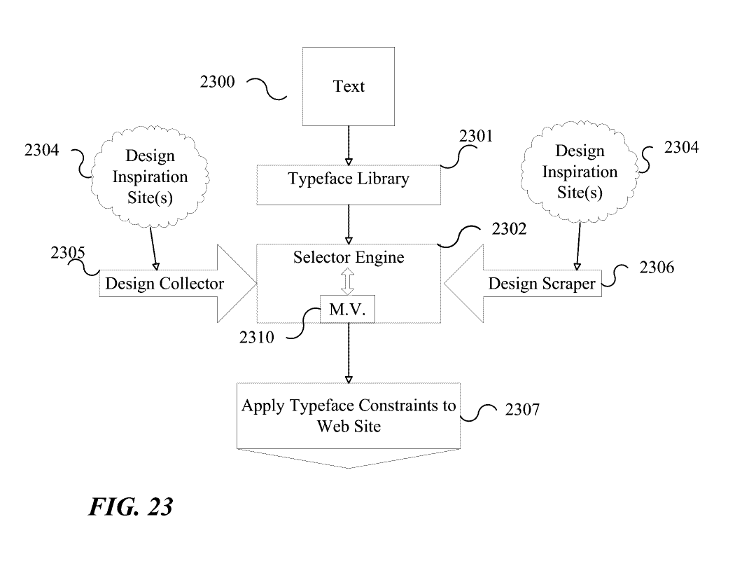

Referring to FIG. 19, this diagram is an example of how a pre-computed layout module 1901 might analyze content 1900 with six items possessing inherent harmony and then assign a pre-computed template 1903, 1904, 1905, consequently preserving computational resources by effectively bypassing the content processing system 1902. Content 1900 is first received and analyzed by the pre-computed layout module 1901 as illustrated by FIG. 18. For purposes of this illustration, it is assumed the resulting harmony score is sufficient to bypass the content processing system 1902. Although significantly harmonious, there may be lingering disharmony within the content 1900. As such, each template may be pre-designed to resolve different and various amounts of lingering disharmony. Accordingly, the module 1902 will assign the template 1903, 1904, 1905, that best resolves any lingering disharmony, thus, resulting in a magazine like publication of the content 1900 without consuming precious computational resources by activating the content processing system (FIG. 4) 1902.

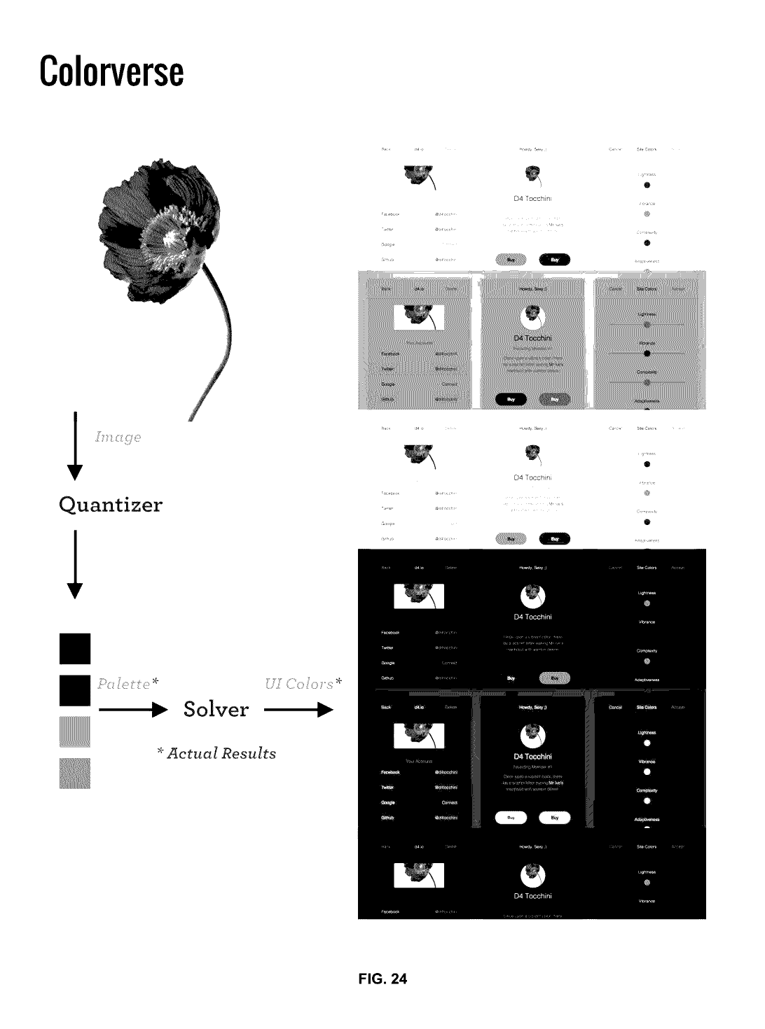

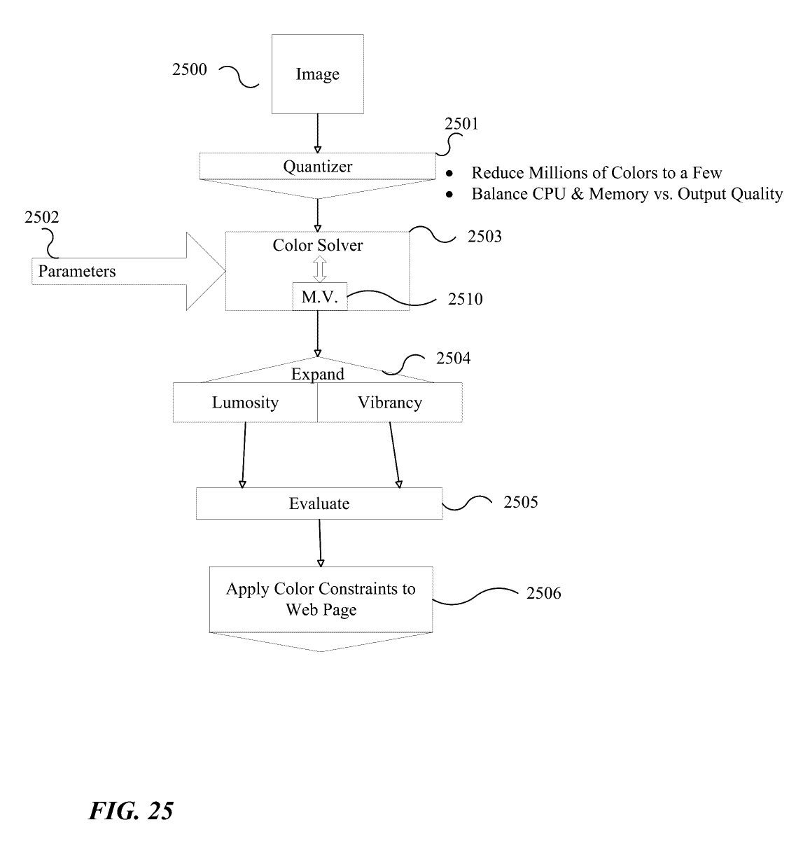

Referring to FIG. 20, this figure illustrates a preferred embodiment of the present solution pathway module 2001 that receives and analyzes user configuration as well as GOM metadata from “Poly” 2000 to form a solution path 2004 to be utilized by the design system in FIG. 21. GOM stands for “generic object model” or is sometimes referred to as “generic data model.” GOM data are binary representations of the relationships each element of the content, such as text length, image color, etc., possess with all other elements. This metadata and user configuration 2000 is delivered to the solution pathway module 2001.

A Solution Pathway Module is an API, or “application programming interface,” that allows the creation of promise-based decision trees. A decision tree 2002 is composed of all possible choices that can be made and also defines how these choices relate to each other. A “promise” is an asynchronous programming method that allows code to listen for a certain condition. Promises are asynchronous because they can run simultaneously with other code in order to monitor or listen. Typical programming must run sequentially, one line after another, or synchronously in other words. The decision tree 2002 in a solution pathway module 2001 is composed of promises that are chained together through which metadata 2000 may be processed to discern an optimal solution. As a result, promise based decision trees cannot fail, or return no solution. This is possible because promises, which can run asynchronously, may be told to respond to unfulfilled events or errors by passing the original metadata down the chain instead of halting or failing.

The behavior tree sub-module 2003 supports the promise-based decision tree 2002 and is composed of nodes. When the decision tree 2002 makes a choice (i.e. a promise is fulfilled), the behavior tree 2003 keeps track of each decision by adding a node to represent that decision, thus, building the behavior tree. Decision after decision the behavior tree 2003 will begin to take shape. When the metadata 2000 has been fully processed by the decision tree 2002, the behavior tree 2003 will be complete. The completed behavior tree 2003 will illuminate a pathway of decisions made by the decision tree 2002, which later instructs the design system (FIG. 21). This pathway is known as the solution path 2004.

Referring to FIG. 21, this illustrates an embodiment of a design system 2102 utilizing multiple solution pathway modules to produce a solution tree 2119 and consequently an HTML rendered page 2120. Design systems 2102 are used in The Grid as solvers for web page designs as well as HTML and style rendering of the resulting webpage 2120. Solution Pathway Module (FIG. 20-2001) is the API (Application Programming Interface) that allows the creation of design systems 2102. A central part of a design system 2102 is the decision tree used to make all the design decisions needed to create a web page. The illustrated design system 2102 is designed to make decisions in two main categories: page wide decisions 2103, and section decisions 2111.

Page wide decisions 2103 include but are not limited to typography 2104, color scheme 2106, and user spectrum 2108. Each page wide decision uses solution pathway modules (FIG. 20-2001) to produce a solution path such as typography solution path 2105, color scheme solution path 2107, and user spectrum solution path 2109. These and other solution paths 2110, constitute the page wide solution set 2121. Section decisions 2111 include but are not limited to section block 2112, block character 2114, and text length 2116. Each section decision uses solution pathway modules (FIG. 20-2001) to produce a solution path such as section block solution path 2113, block character solution path 2115, and text length solution path 2117. These and other solution paths 2118, constitute the section solution set 2122. Together, the page wide solution set 2121 and the section solution set 2122 comprises the final solution tree 2119. Having completed the solution tree 2119 it is now possible to render a fully published, magazine quality, HTML webpage.

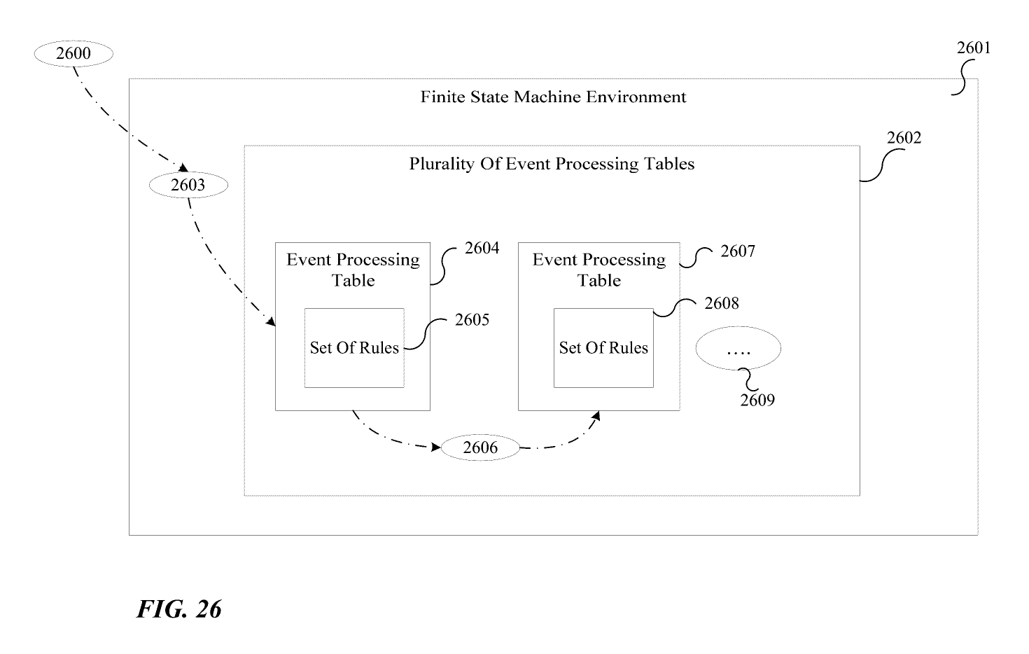

Referring to FIG. 22, this illustrates a preferred embodiment of the present invention's design engine 2202, which utilizes several sub-engines. These include but are not limited to a typography engine 2203, a color engine 2204, a decoration engine 2205, an animation engine 2206, a layout engine 2207, and a navigation engine 2208. Each sub-engine works in tandem with, indeed extends, the present invention's general-purpose artificial intelligence (“AI”) system herein referred to as MultiVerse (“M.V.”) 2210 to accomplish design tasks necessary to render a fully published, magazine quality, HTML webpage 2209.

The design engine 2202 is the system that generates a perceivably unique site design by harmonizing a complex set of typography, color, decoration, and layout decisions with content's metadata and user preferences. The design system employs several discrete sub-engines that mirror areas of expertise web designers employ when exercising their craft. As stated previously these include but are not limited to a typography engine 2203, a color engine 2204, a decoration engine 2205, an animation engine 2206, a layout engine 2207, and a navigation engine 2208. Each sub-engine encapsulates a type of creative expertise in the form of declarative rules, machine knowledge, and decision graphs. Internally, the design engine 2202 uses user preferences to dynamically assemble very large decision graphs that the site's content will be evaluated against. Each node in the decision graph represents a point of decision and the edges from each node represent a possible choice. For example, a choice may be “whether a section should have a color scheme classified as dark, light or vibrant,” or “what style of menu system best matches the site's navigation” to name a couple.

All possible complete paths through the generated decision graph represent all possible designs available to a unique combination of site content and user preference. Using a method to compute the number of all possible such paths, it is commonly seen that the number of possible design outcomes exceed the largest number in JavaScript! In other words the number of decisions possible for each webpage exceeds the largest number possible in JavaScript. Hence, separate sub-systems are required in order to accommodate this limitation. The design system 2202 uses the general purpose AI 2210 to generate and search this relatively massive possibility space in a performable and scalable manner.

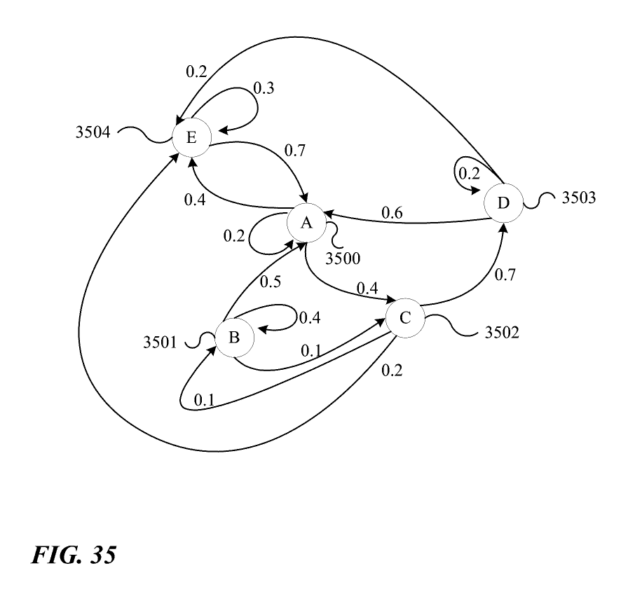

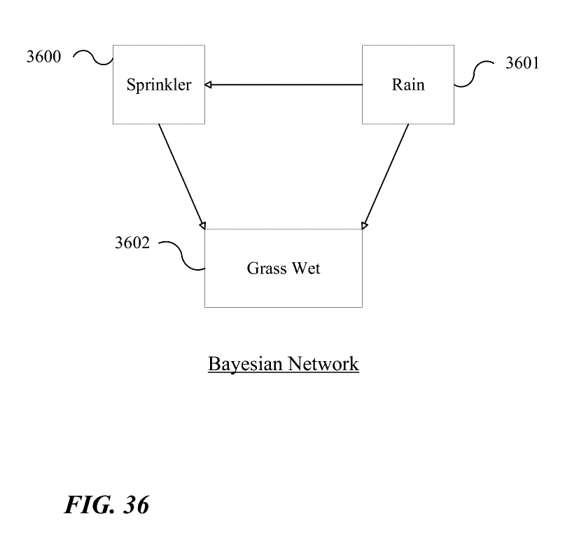

Ultimately, many acute design decisions are chosen, i.e. collapsed from the possibility space. This is accomplished by searching through the decision graph node-by-node, decision-by-decision. At each step in the search it calculates a probability of what path to take next based on content characteristics and a memory of accumulated states. This allows the present invention to learn and adapt. Using calculated probabilities, it stochastically chooses a new path and evaluates the validity of new decision paths against a set of constraint rules and Machine Learning classifiers. (See FIG. 35 and FIG. 36 for further explanation). The result is as follows: if a rule is broken or the result of the decision path is classified as invalid, the AI backtracks to previous decision nodes to try a new decision path, hence, never analyzing a failed decision path more than once. The search for an adequate decision pathway ends when a complete set of decisions is made. In other words, the search ends when all metadata has been processed and evaluated and all decision pathways return valid. This collapsed possibility is then converted into a structured document that represents the HTML, CSS and JavaScript of a complete static webpage.

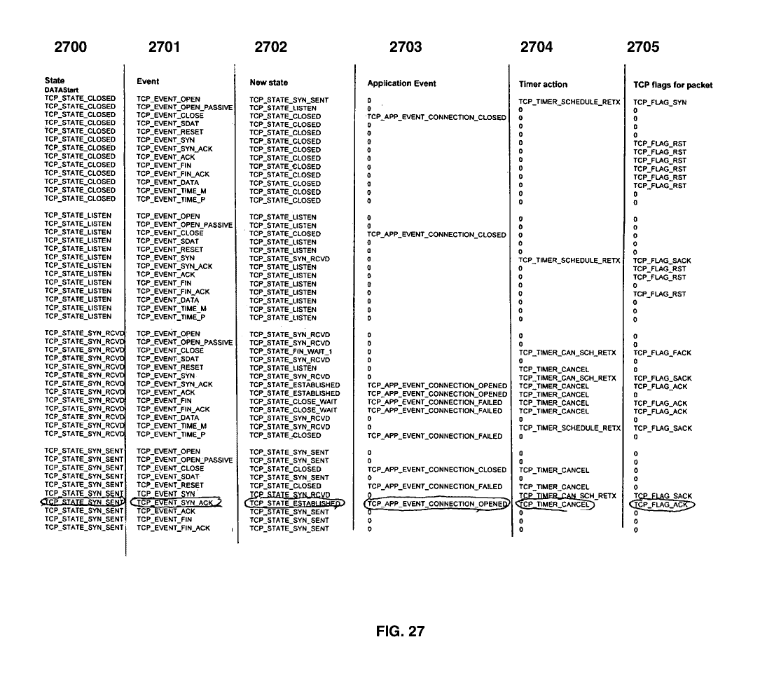

Referring to FIG. 23, this illustrates one preferred embodiment of the typography sub-engine within the design engine 2202. The typography sub-engine extends MultiVerse AI 2310 with semantic, semiotic, and culturally relevant knowledge of typography. As the nature of this knowledge is dynamic, just as is the nature of culture and language, it obliges the AI to constantly distill new knowledge through research.

Typography metadata distilled from content 3300 is received first by the typeface library. This library 2301 runs the information through in-house algorithms to build data about their properties. These properties include but are not limited to typographic heights, widths, contrast ratios, classifications, etc. Establishing these properties is essential. This enables the selector engine 2302 working in tandem with, and extending the AI's 2310 knowledge, to reason about the properties programmatically in much the same way as a human designer would. The selector engine 2302 is tasked, then to specify rules, patterns, and logic in a designer-friendly format.

As mentioned previously, the nature of typography changes or evolves in parallel with culture and language, changing as they change. Such a dynamic problem requires an equally dynamic solution. Supplementing the selector engine 2302, and consequently the AI 2310, is another system(s) which constantly collect 2305 or scrape 2306 the highest quality design inspirations from sites in order to build a living model of real-world typeface usage, popularity, and common pairings, etc. The result is a graph or table spanning thousands to millions of connections, which may be queried by the AI 2310 when creating a typography rule set for the finished webpage 2307. Hence, a constantly evolving typography universe can be accommodated for by a constantly learning, and updating AI 2310. When finished, the AI 2310 collapses these constraints to find interesting and appropriate typeface combinations and render them onto websites 2307.

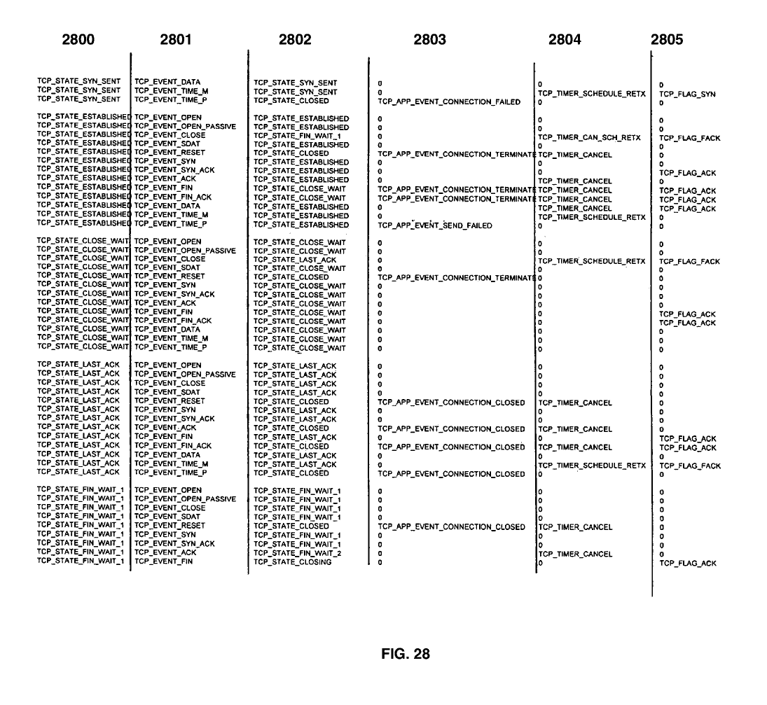

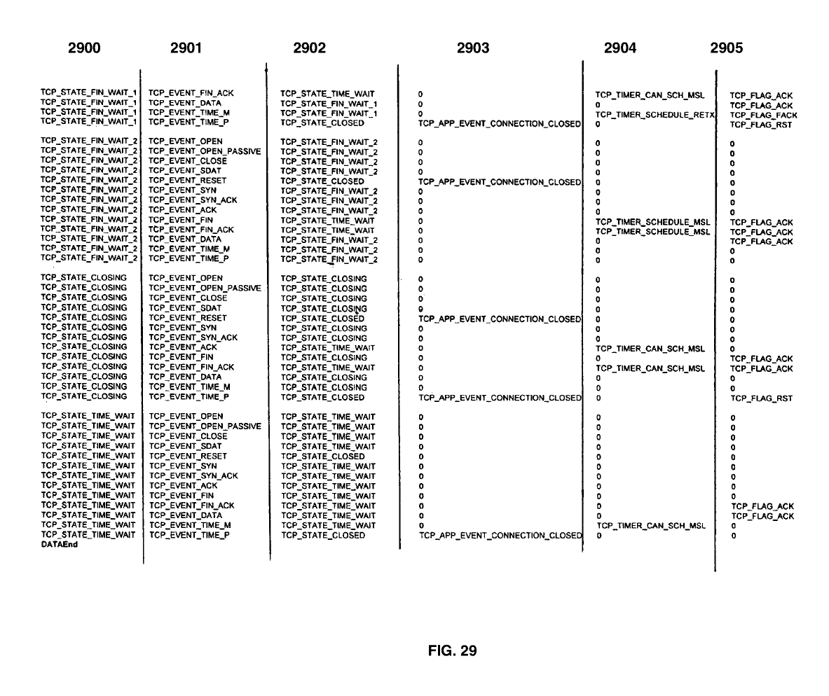

Referring to FIG. 24, presented here are actual results of an image of a flower processed by the present invention's color sub-engine contained within the design engine (see FIG. 22). The resulting collapsed color constraints are shown on the right. Listed here are only six of what may be thousands of possible results produced by the solver. The process is described in more detail in FIG. 25.

Referring to FIG. 25, this illustrates a preferred embodiment of the present invention's color sub-engine contained within the design engine (see FIG. 22). In general, the color sub-engine is tasked with discerning acceptable user interface color application. It generates color values for major user interface (UI) such as text, buttons, icons, etc., and also generates color values for drop-shadows for each element and line dividers, etc. Given a palette of only five semi-varied colors, the color engine is capable of generating 10,000+ different valid UI color solutions. An optimized configuration is available for real-time applications, where the color engine can extract the colors of an image and produce the first optimal UI solution in 30-90 ms. The system employs several heuristics established in multi-hue cartography and typographic graphic design. Multi-hue cartography is the study and practice of making maps of multitudinous color hues. Dynamically applying a multi-hue color palette of arbitrary size to a UI is not a linear, trivial process and is especially difficult when working with multiple hues. The palette colors most often have to be carefully manipulated to maintain legibility and effective visual hierarchy. From an input set of colors, the color sub-engine generates thousands of variations of ways a palette can be applied to a UI or other typographic document, each variation maintaining legibility while conforming to web content accessibility guidelines (WCAG) 2.0 for elements such as contrast values for example. For reference, WCAG is part of a series of a web accessibility guidelines published by the Web Accessibility Initiative (WAI) of the World Wide Web Consortium (W3C), the main international standards organization for the Internet. They are a set of guidelines that specify how to make content accessible, primarily for people with disabilities—but also for all user agents, including highly limited devices, such as mobile phones.

The quantizer 2501 is input an image 2500 and outputs a palette of the most visually significant colors within the image to the color solver 2503. Color quantization is the process of reducing an image with thousands or millions of colors to one with fewer. The present invention is currently capable of reducing millions of colors down to just five. The quantizer 2501 is tasked with reducing millions of colors to just a few while simultaneously balancing speed, CPU and memory requirements in order to minimize the perceptual loss in output quality. The color solver 2503 is input a color palette as well as other parameters 2502, including but not limited to user preference, voice, tone, etc. The solver 2503 outputs a solution of color values that map to common UI elements. To accomplish this, the solver 2503 first expands 2504 each input palette color over a range of luminosities and vibrancy, while maintaining its original hue. For reference, typical HTML, CSS, and JavaScript websites apply colors using multiple layers with the lowest layer becoming the background, and the top layer being the foreground, which consequently overlap layers with identical coordinates below it. Next, it analyzes a color by searching layer by layer of UI elements, stochastically evaluating the expanded ranges using the present invention's AI 2510 for colors classified as appropriate for the type of UI layer while maintaining legibility atop the color properties of the layer below it. Here, parameters may be supplied to constrain solutions to a number of hues within a range of luminosity or vibrancy. Vibrant solutions may be generated from color palettes that are perceivably desaturated by enhancing “dormant” hues in the palette. Upon collapsing the decision color graph, the AI 2510 is ready to apply color constraints to the webpage 2506.

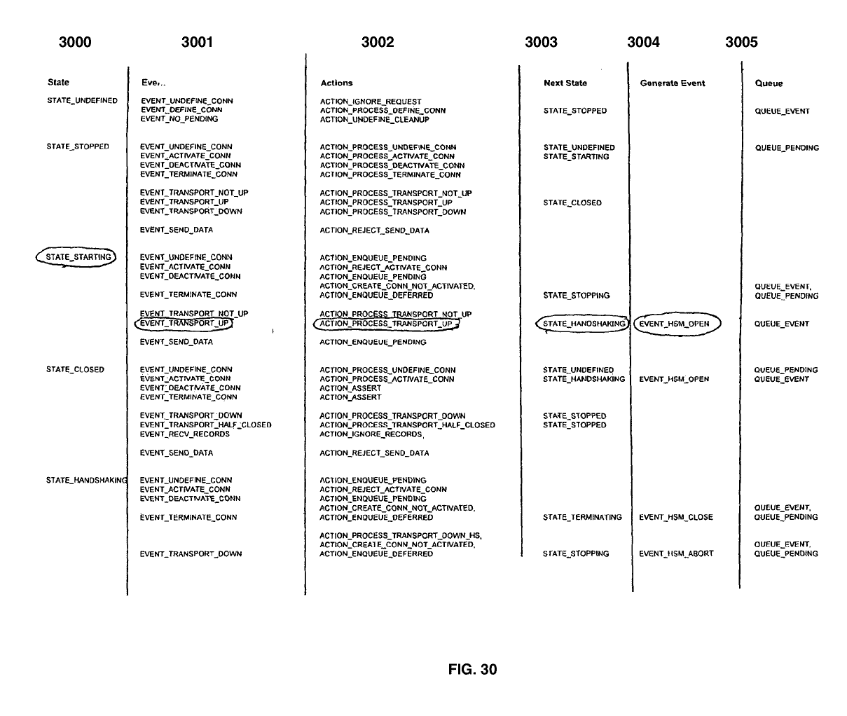

Referring to FIG. 26, this illustrates a high level view of one example of a table driven processing system. Speaking generally, event driven programming is a programming paradigm in which the flow of the program is determined by the events that occur, such as user actions, sensor outputs, or messages from other programs. In an event-driven program there may typically be a main loop whose is tasked with constantly listening for events to occur. Upon which, the loop triggers another function, such as an event table with corresponding rule set.

Here, the environment 2601 receives input 2600. Common examples of user input include but are not limited to a mouse click, or keystroke, etc. The environment 2601 listens for the events and, upon receiving one, delivers instructions 2603 regarding the input 2600 to the first event-processing table 2604 of multiple tables 2602 for evaluation according to a set of rules 2605. The instructions are evaluated by the set of rules 2605, and in doing so may trigger another event 2606, upon which the first event table 2604 will deliver instructions to a second event-processing table 2607 to be evaluated by a second set of rules 2608. This process may repeat 2609 thousands or millions of times depending on the complexity of the system and the solution desired. For purposes of the present invention, artificially intelligent webpage design constitutes an order of complexity requiring millions of decisions, accommodating a near infinite number of possible events that may occur at random. Thus, it is impossible to illustrate the present invention's table driven event-processing system in its entirety here. However this method of processing as described is sufficient to allow the reader to extrapolate and compound the process to any order of magnitude or depth. Consider the complexity of a rule set, when satisfied, that will trigger multiple events in multiple subsequent tables, which in turn may each separately trigger an equal number of events in deeper tables. It becomes clear how quickly this method can become complex in a matter of two or more events. Though daunting, it nevertheless remains true that the more complex the solution desired, the more complex the processing system must be capable of in order to facilitate the solution. Table driven event processing methods allow for such complexity, making it one method of choice for the present invention.

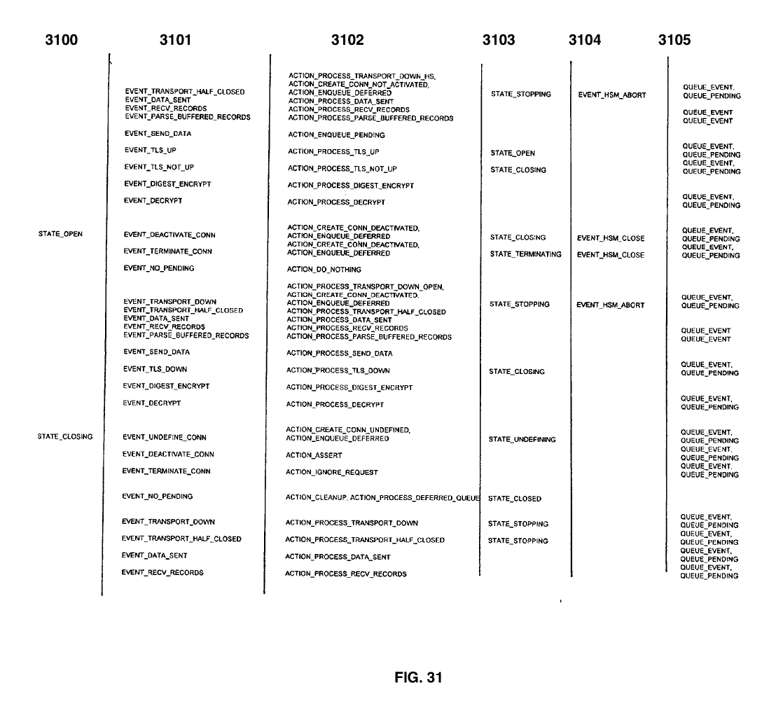

Referring to FIG. 27, FIG. 28, and FIG. 29, these figures collectively demonstrate one possible event-processing table consisting of multiple columns including state 2700, event 2701, new state 2702, application event 2703, timer action 2704, and TCP flags 2705. For the reader's reference, TCP is defined as “Transmission Control Protocol.” The rows within each column demonstrate every possible combination of state 2700 and events 2701 with corresponding rules and actions to take, such as what new state 2702 or event table will be called next, and what other application event 2703, timer action 2704, or flags 2705 will be triggered upon the occurrence of the specific state 2700 and event 2701.

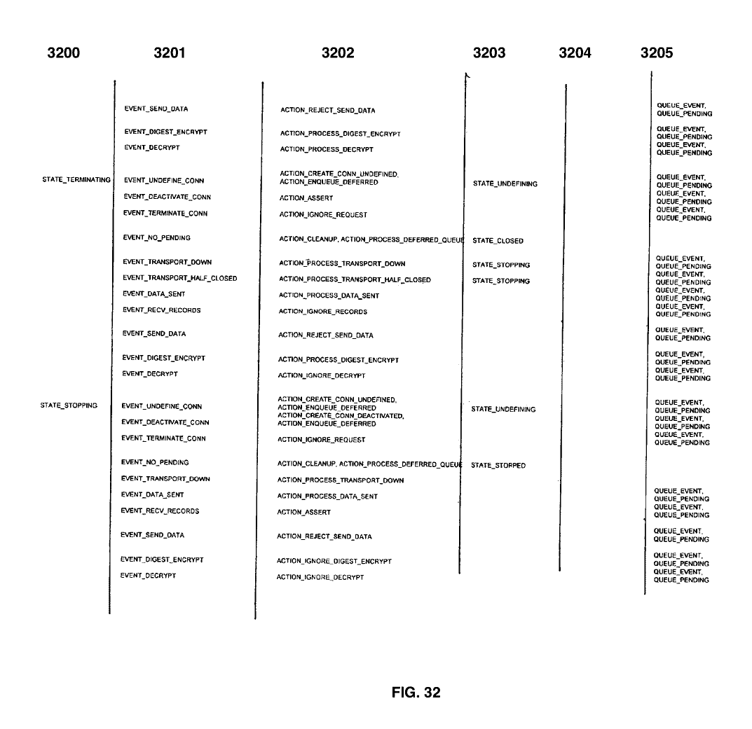

Referring to FIG. 30, FIG. 31, and FIG. 32, these figures collectively demonstrate another possible event-processing table, which may be called by the first event table, consisting of multiple columns including state 3000, event 3001, actions 3002, next state 3003, generate event 3004, and queue 3005. Similar to the first table, the rows within each column demonstrate every possible combination of state 3000 and events 3001 with corresponding rules and actions 3002 to take, such as what new state 3003 or event table will be called next, which event to generate 3004, and which queue label 3005 will be triggered upon the occurrence of the specific state 3000 and event 3001. It is important to note this table (FIGS. 30 to 32) may be called by the first table (FIGS. 27 to 29), upon which, this table (FIGS. 30 to 32) may recall the first table again (FIGS. 27 to 29). The present invention is not limited to sequential order but may, as programing dictates, call any table in any order. As mentioned in the brief description section of this application, these tables have evolved in complexity into what is presently known by this invention as table graphs. Consider table graphs thousands of columns wide and thousands deep. Consider also, there may be thousands or millions (pending necessity) of said table graphs that may be called at any given time. For these reasons, it becomes impossible to illustrate the present invention's table graph processing system in its entirety here. For illustrative purposes only however, these figures represent basic and relatively simple tables for the reader's understanding. This method of processing, as described, is sufficient to allow the reader to extrapolate and compound the process to any order of magnitude or depth to accommodate the artificial design of magazine-quality websites featuring rhythmic and polyrhythmic patterns.

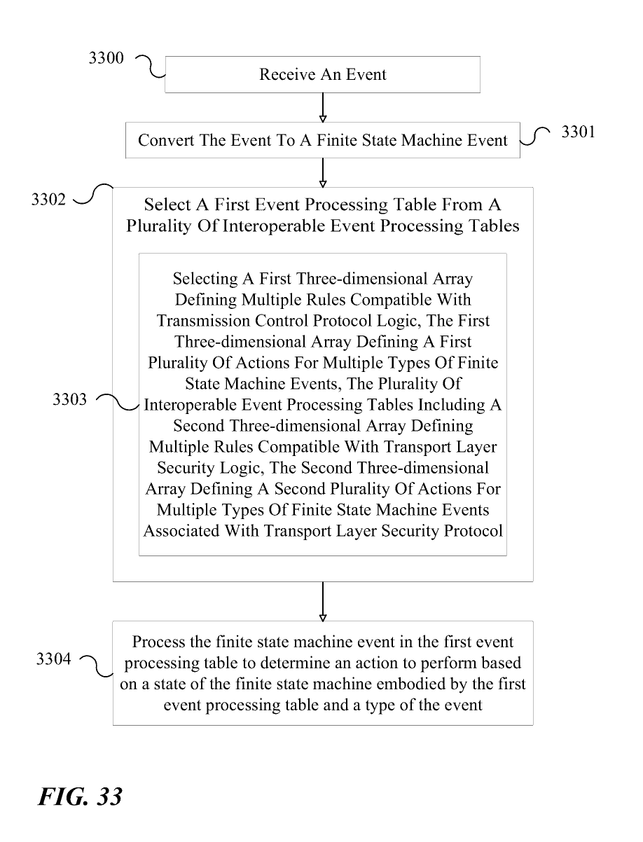

Referring to FIG. 33, this illustrates the chronological flow of the method of table driven event processing utilized by finite state machines. This method of processing is common in the field of computer science, particularly in music, graphics processing, and artificial intelligence. To begin, an event 3300 must first be received or generated. For example, this can be done by user input, such as a mouse click or keystroke, or may be generated by another program, or system. The event is converted into data that the finite state machine can understand 3301. Depending on the event triggered, a processing table is selected from a multitude of event processing tables 3302. Various examples of what may be accomplished by different tables are enumerated 3303. Once accomplished, the finite state machine processes the first event-processing table to determine an action to perform in consequence of the current state and the type of event 3304. This process may be repeated as necessary until no further triggering event is received.

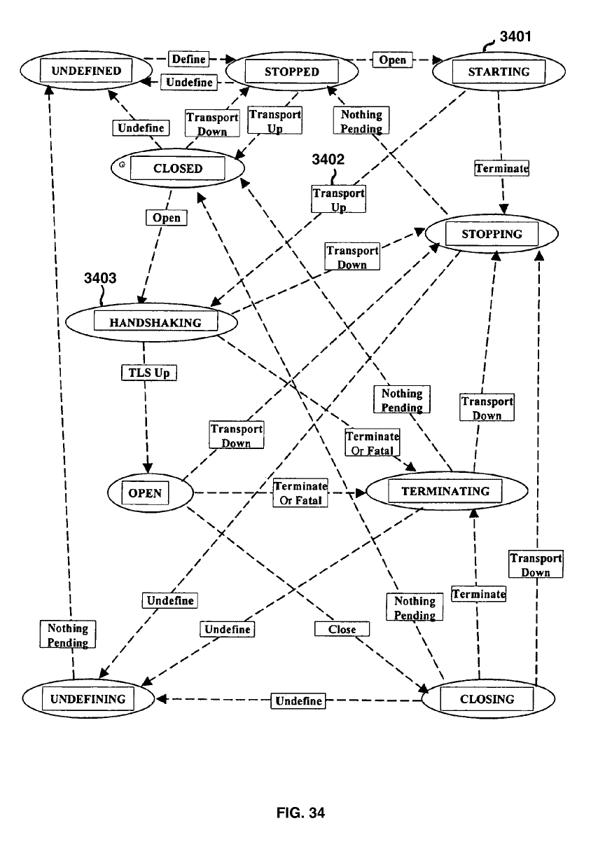

Referring to FIG. 34, this illustrates visually what pathways a table driven processing system may look like in relation to all others. Beginning at 3401 one possible pathway may lead to 3402, which in turn may lead to 3403. From there pathways diverge. This illustration is meant to merely give the reader a basis upon which to build and extrapolate. As mentioned previously, this method may extend to thousands or millions of tables thus rendering it impossible to illustrate all possible pathways of this invention in its entirety here. This figure is sufficient to allow the reader to extrapolate and compound the process to any order of magnitude or depth.

Referring to FIG. 35, this illustrates what is known to professionals in the field of computer processing as a Markov Chain. A Markov chain is a stochastic process with the Markov property. The Markov property is usually characterized as “memorylessness.” The term “Markov chain” refers to the sequence of random variables a process moves through, with the Markov property defining serial dependence only between adjacent periods (as in a “chain”). It can thus be used for describing systems that follow a chain of linked events, where what happens next depends only on the current state of the system and not the sequence of events that preceded it. Utilizing this stochastic method, the present invention's AI is capable of calculating probabilistically the likelihood of which state the system ought to transfer to next. This allows the present invention to “fill in the gaps.” For example, when a pathway leads to several decisions, all of which are deemed valid but only one may be chosen, this method allows the system to stochastically choose one. Hence, preventing the system from failing to return a solution. The contrast is also true. For example, when a pathway leads to zero valid decisions, this method allows the system to stochastically choose or fill in the gaps based on probability of what the next state ought to be.

Beginning in state A 3500, the system is instructed, given a solution probability of 0.2, to remain in state A 3500. If the solution probability is 0.4 the system is instructed to transition to state C 3502. From state C 3502, should the solution probability become 0.1 to transition to state B 3501; if it reaches 0.7, transition to state D 3503. From state D 3503 should the solution probability become 0.2, transfer to state E 3504 and so on and so forth. As explained previously, this method may extend to thousands or millions of chains, thus rendering it impossible to illustrate all possible Markov Chains utilized by the present invention's AI in its entirety here. However, this figure is sufficient to allow the reader to extrapolate and compound the process to any order of magnitude or depth.

Referring to FIG. 36, this illustrates a simple Bayesian network. Similar networks of infinitely greater size and complexity may be utilized by the present invention to evaluate, for example, solution probabilities of Markov Chain states, and consequently, which state to transition to next. The logic presented in this illustration does not represent actual logic utilized by the present invention but is merely a for illustrative purposes. The logic is as follows: rain 3601 influences whether the sprinkler 3600 is activated, and both rain 3601 and the sprinkler 3600 influence whether the grass is wet 3602. Hence, if the grass is wet 3602 then it is possible the sprinklers 3600 as well as the rain 3601 were the cause. Depending on what data is provide the AI, the probability the rain 3601 caused the grass to be wet 3602 may be 0.7, for example, if the data indicates the grass is in Washington State. Alternatively, if the data indicates the grass if located in Arizona, the probability may be as low as 0.1, and the AI may transition to the next appropriate state.

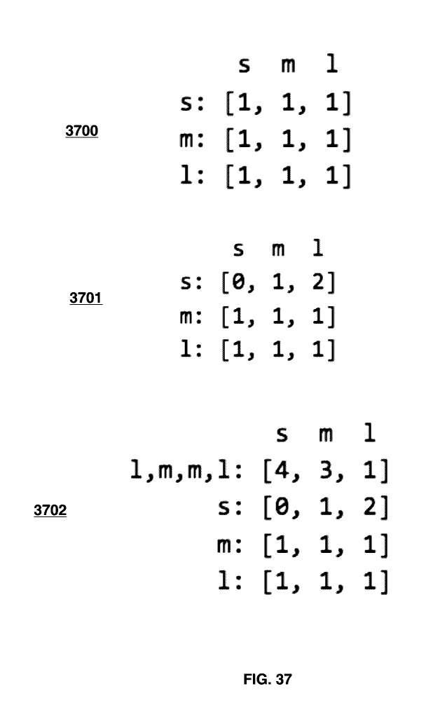

Referring to FIG. 37, this illustrates an example of what is known to professionals in the field as a Markov Transition Matrix and may be utilized by the present invention's AI. The Markov matrix behaves like a weak constraint applied by the present invention's AI. It's a new value distribution strategy, and works as follows: let's say we have a Y_size branch with three possible paths “s”, “m” & “l” (small, medium, large). If each path were equally likely to be chosen at random, our Markov transition matrix would look like 3700.

If however, we want never to have two smalls in a row, and after a small, larges are preferred twice as much as mediums, it would look like 3701. If we assume each row in the matrix is the previous state and each column is a state we can transition to, then we can add additional rows to describe more specific states. For example, if we want a different set of probabilities when there's a previous pattern of [l,m,m,l] it would look like 3702. Thus, by adding more rows, we can describe how the solutions should tend to change based on state. This is like a weak constraint in that, it will still consider all values in a domain, but it will tend to begin with the ones that have higher probability, maintaining solvability. Generally, the system is under-constrained and Markov Transition Matrices allow the present invention's AI to respect the hard constraints, but fill in the gap with intelligent randomness.

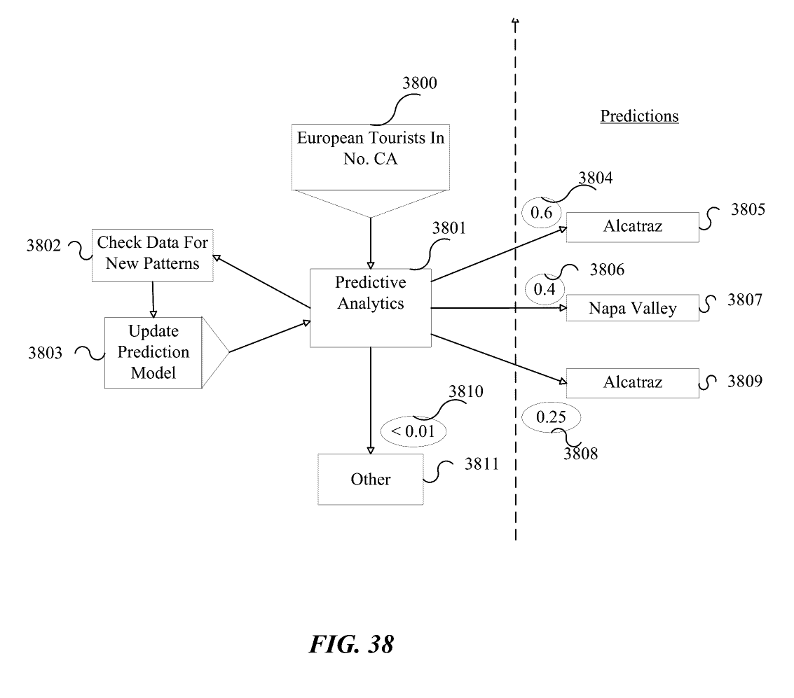

Referring FIG. 38, this illustrates a simple predictive analytic method, analogous to those utilized by the present invention, to predict tourist destinations of Europeans who visit Northern California. Here is presented an example of predictive analytics at work, the preferred method of the present invention's Multi Verse AI for maintaining harmony within all aforementioned design processes. Utilizing a method known to those in the trade as Machine Learning, the predictive analytics module 3801 is tasked with predicting tourist destinations for Europeans visiting North California.

Machine Learning is the science of finding patterns and making predictions from data based on work in multivariate statistics, data mining, pattern recognition, and predictive analytics. In other words, machine learning is the study of computer algorithms that improve automatically through experience. Machine Learning allows for AI to mine data to find patterns and make predictions about the future based on current and historical facts. Predictive analytics encompasses a variety of statistical techniques from modeling, machine learning, and data mining that analyze current and historical data to make predictions about unknown future events. Predictive analytics are commonly used in business to exploit patterns found in current and historical data, identifying risks and opportunities, and guiding decision-making. In particular, predictive analytics provides for each individual or event in order to determine organizational processes that are applicable across large numbers of individuals or events.

Here, raw data 3800 is initially provided regarding European tourists visiting North California. Based on this data, the predictive analytics module (PA) 3801 determines there is a pattern present in the data and predicts three relevant tourist destinations, Alcatraz 3805 with a probability of 60 percent 3804, Napa Valley 3807 with a probability of 40 percent 3806, and China Town 3809 with a probability of 25 percent 3808. The PA also predicts other 3811 destinations with a probability of less than one percent 3810 and consequently discards these predictions as statistically irrelevant. It is important to note that these probabilities sum to more than 100 percent. In fact, they add to over 125 percent. This is not impossible. What this means is the data 3800 shows tourists visiting more than one location. This simple example of PA was tasked with predicting one location a European tourist might go and not all places they will visit during their trip. Furthermore, the AI may subsequently alter probabilities by incorporating Markov Transition Matrices as illustrated in FIG. 37. This allows the system to effectively add constraints to the PA system while maintaining rhythmic and polyrhythmic prediction capabilities through the use of Markov chains as (see FIG. 35). For example, though the data may predict Alcatraz 3805 with a 60 percent probability 3804, if the user indicates he or she has a crippling fear of prisons and would never visit Alcatraz 3805, the AI will apply a transition matrix (see FIG. 37) that alters the probability outcome of Alcatraz 3805 to zero percent, while increasing the likelihood of other prediction pathways to Nappa Valley 3807 and China Town 3809.

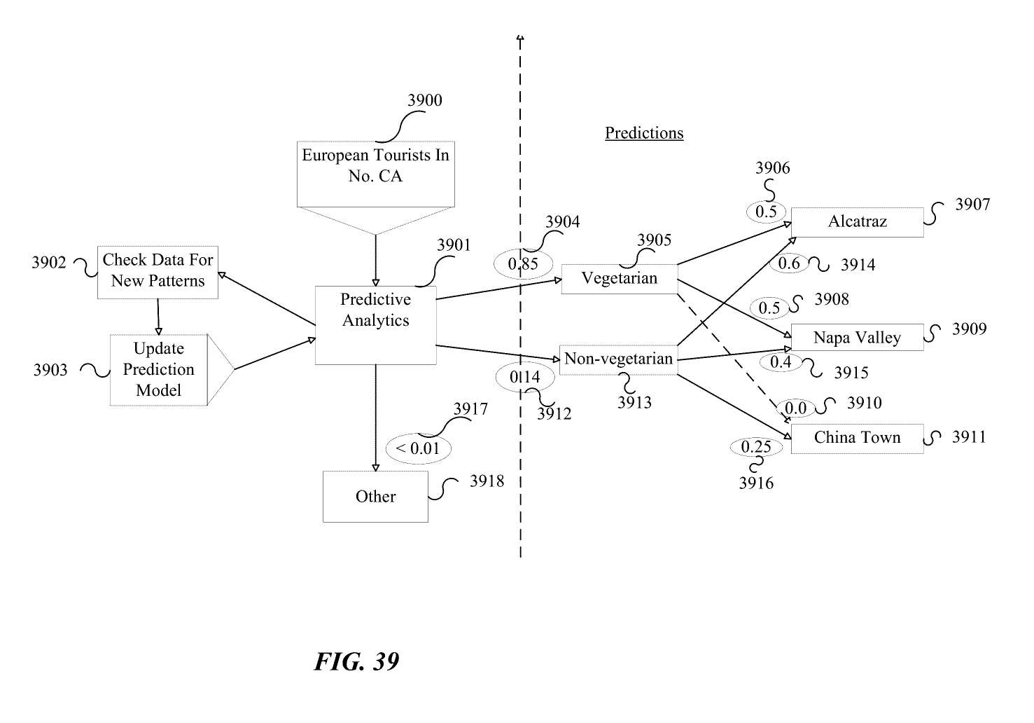

Upon completion, the PA 3801 continuously checks for new data and new patterns 3802. Upon discovering one, the PA is updated 3803 to encompass any new data patterns found. An example of this is illustrated in FIG. 39. For the purposes of the present invention, the MultiVerse AI is tasked with designing a magazine-like quality webpage with rhythmic and polyrhythmic harmony instead of European tourist destinations in Northern California. This method may extend to thousands or millions of predictions, thus rendering it impossible to illustrate all potential outcomes of the present invention here. However, this figure is sufficient to allow the reader to extrapolate and compound the process to any order of magnitude or depth to accomplish the present invention's purposes.

Referring to FIG. 39, this illustrates an evolved predictive analytic method, analogous to those utilized by the present invention, to predict tourist destinations of Europeans who visit Northern California. However, in this illustration as compared to FIG. 38 the architecture has evolved autonomously after discovering a new pattern latent within the data, and may now predict destinations of European tourists who are vegetarian.

Here, raw data 3900 is initially provided regarding European tourists visiting Northern California. Based on this data, the predictive analytics module (PA) 3901 determines there is a pattern and predicts three relevant tourist destinations, Alcatraz 3907 with a probability of 60 percent 3914, Napa Valley 3909 with a probability of 40 percent 3915, and China Town 3911 with a probability of 25 percent 3916. The PA also predicts other 3918 destinations with a probability of less than one percent 3917 and consequently discards these predictions as statistically irrelevant. This time however, the PA has learned if a tourist is vegetarian, said tourist is zero percent likely 3910 to visit China Town 3911, 50 percent likely 3906 to visit Alcatraz 3907, and 50 percent likely 3908 to visit Nappa Valley 3909. Upon completion, the PA 3901 continuously checks for new data and new patterns 3902. Upon discovering one, the PA is updated 3903 to encompass any new patterns found. This process continues indefinitely, allowing the present invention's AI the ability to learn through experience.

As demonstrated previously (see FIG. 38), the AI may subsequently alter probabilities by incorporating Markov Transition Matrices (see FIG. 37). This allows the system to effectively add constraints to the PA while maintaining rhythmic and polyrhythmic prediction outcomes using Markov chains (see FIG. 35) and Bayesian Network logic (see FIG. 36). For example, though the data predicts a vegetarian 3905 may visit Alcatraz 3907 with a 60 percent probability 3914, if the user indicates he or she has a crippling fear of prisons and would never visit Alcatraz 3907, the AI will apply a transition matrix (see FIG. 37) that alters all probability pathways leading to Alcatraz 3907 to zero percent, while increasing the likelihood of other prediction pathways to Nappa Valley 3909 and China Town 3911, etc.

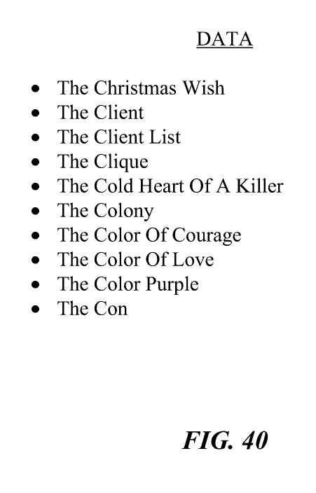

Referring to FIG. 40, this illustrates by example, raw movie tile data that may be consumed by the present inventions predictive analytic architecture for the purpose of predicting future movie titles.

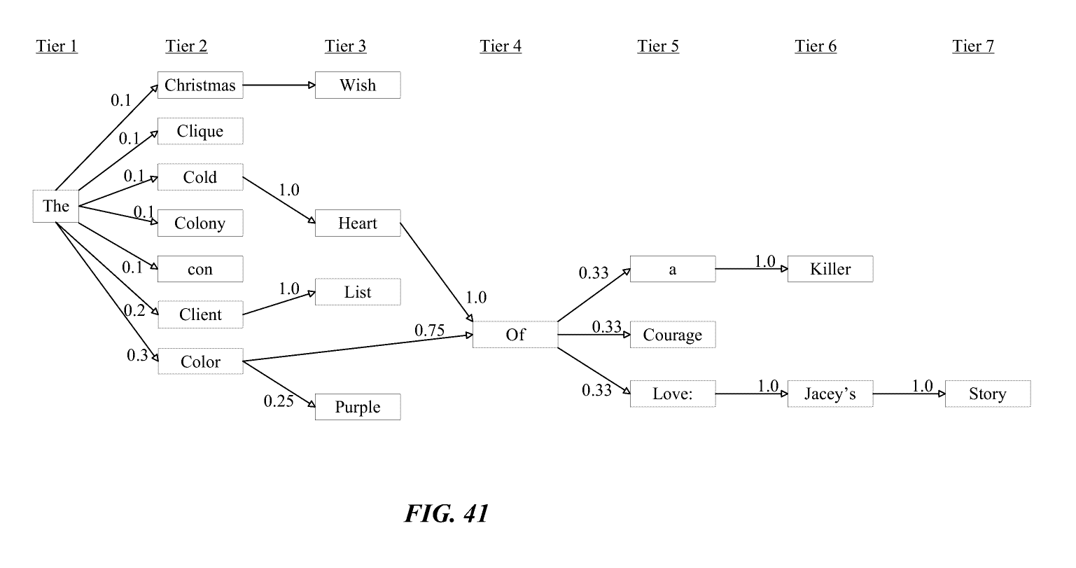

Referring to FIG. 41, this illustrates by example the predictive analytic probability pathways according to movie title data found in FIG. 40 in order to produce movie titles with tier-seven complexity. This figure is analogous to those utilized by the present invention and not meant to represent actual architecture of the present invention. Instead of text, the present invention creates similar probability diagrams using raw data such as colors, tones, contrast, text, typography, animation, etc., allowing the AI to predict and harmonize design solutions with corresponding rhythmic and polyrhythmic probability patterns. As demonstrated previously, the AI may subsequently alter probabilities by incorporating Markov Transition Matrices (see FIG. 37). This allows the system to effectively add constraints to the PA while maintaining rhythmic and polyrhythmic prediction outcomes using Markov chains (see FIG. 35) and Bayesian Network logic (see FIG. 36). This method may extend to thousands or millions of tiers, thus rendering it impossible to illustrate all potential outcomes of the present invention. However, this figure is sufficient to allow the reader to extrapolate and compound the process to any order of magnitude or depth to accomplish the present invention's purposes.

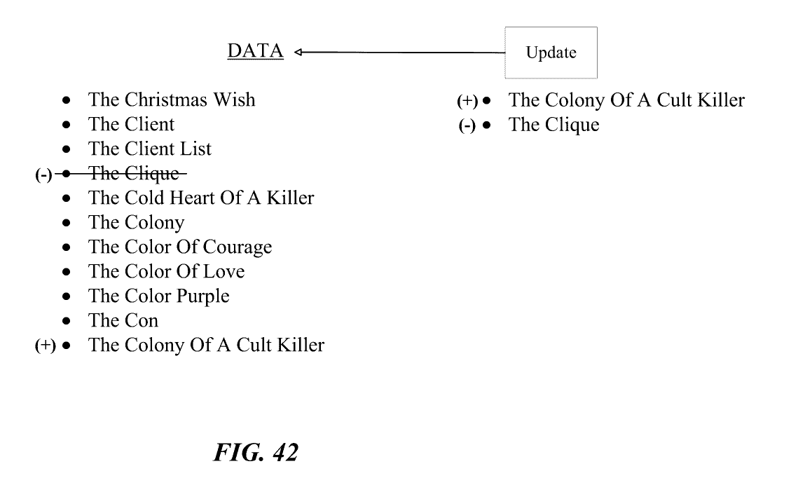

Referring to FIG. 42, this illustrates by example, evolved or updated raw movie tile data that may be consumed by the present inventions predictive analytic methods utilized by the AI for the purpose of predicting future movie titles. The updated data introduces an extra title, “The Colony of a Cult Killer,” and removes “The Clique” from future rhythmic and polyrhythmic predictions.

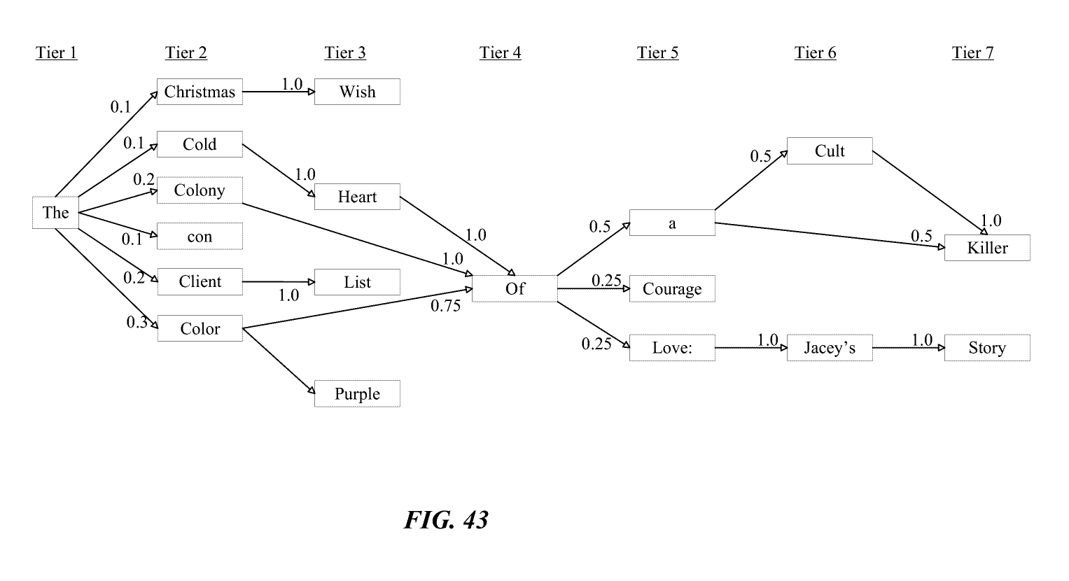

Referring to FIG. 43, this illustrates by example an evolved predictive analytic probability pathway according to movie title data found in FIG. 42 in order to produce movie titles with tier-seven complexity. The evolved probability pathway no longer features “The Clique” as a possible solution pathway. Furthermore, the graph has evolved to include the possibility of finding “The Colony of a Cult Killer” as a solution pathway. This figure is analogous to those utilized by the present invention and not meant to represent actual architecture of the present invention. Instead of movie titles, the present invention creates similar probability diagrams using raw data such as colors, tones, contrast, typography, animation, etc., allowing the AI to predict and harmonize design solutions with appropriate rhythmic and polyrhythmic probability patterns. As demonstrated previously the AI may subsequently alter probabilities by incorporating Markov Transition Matrices (see FIG. 37). This allows the system to effectively add constraints to the PA while maintaining rhythmic and polyrhythmic prediction outcomes using Markov chains (see FIG. 35) and Bayesian Network logic (see FIG. 36). This method may extend to thousands or millions of tiers, thus rendering it impossible to illustrate all potential outcomes of the present invention. However, this figure is sufficient to allow the reader to extrapolate and compound the process to any order of magnitude or depth to accomplish the present invention's purposes.

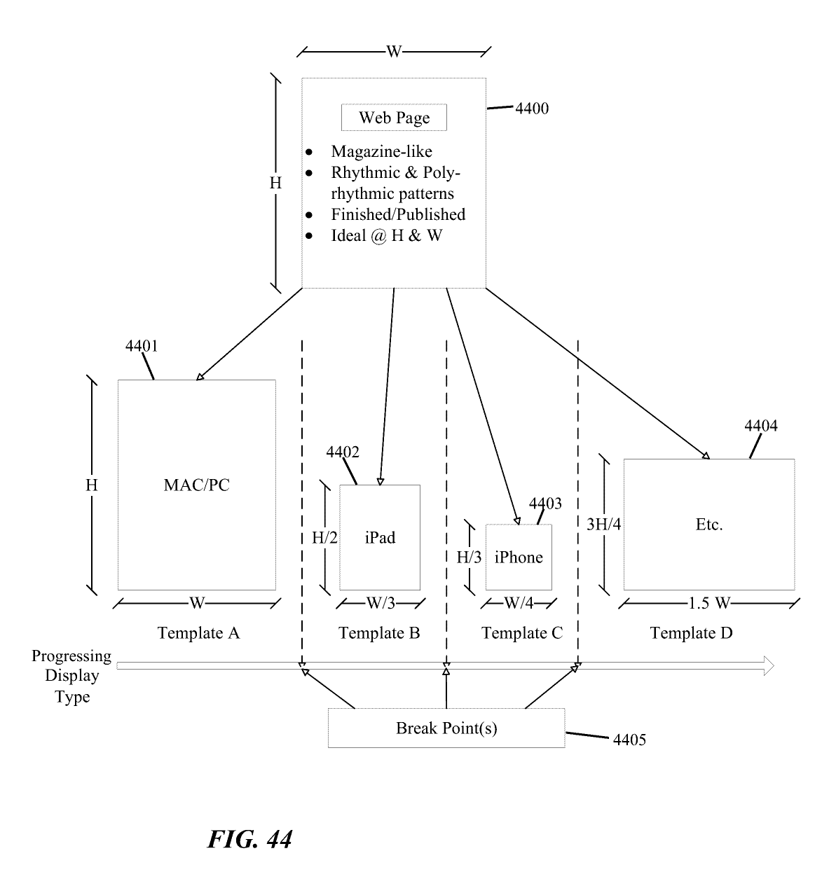

Referring to FIG. 44, this illustrates a block diagram of one preferred method utilized by the present invention, which autonomously identifies breakpoints between various display types, and a corresponding template for each. Here, a finished, magazine-like quality webpage 4400 is ready for publishing. Rhythmic and polyrhythmic harmonies are present at an ideal display height (“H”) and width (“W”). Current webpage design, done by professionals, must include various templates for all possible display types, and not only those with an ideal height of H and W. For example, if a Mac/PC 4401 accesses the webpage 4400 the webpage 4400 will display correctly with high quality. However, if an iPad 4402, iPhone 4403, etc. 4404, attempts to access the webpage 4400 this may injure the quality and disrupt rhythmic and polyrhythmic harmonies, rendering the webpage unattractive or inaccessible altogether. Professional webpage designers resolve this issue by designing templates for each and every display type that may access the webpage. This is an exhaustive process, and very expensive. The present invention employs methods and processes of autonomously identifying the break point(s) 4405 between display types, and consequently redesigning the webpage 4400 to accommodate each and every display type. Breakpoint(s) 4405 are the point at which the webpage 4400 content will respond to provide the user with the best possible layout to consume the information. In other words, a breakpoint 4405 is a theoretical point where the ideal webpage 4405 no longer remains ideal because it's accessed by a device with display dimensions it was not designed for. Pre-designed templates are one method employed by the present invention to resolve this issue.

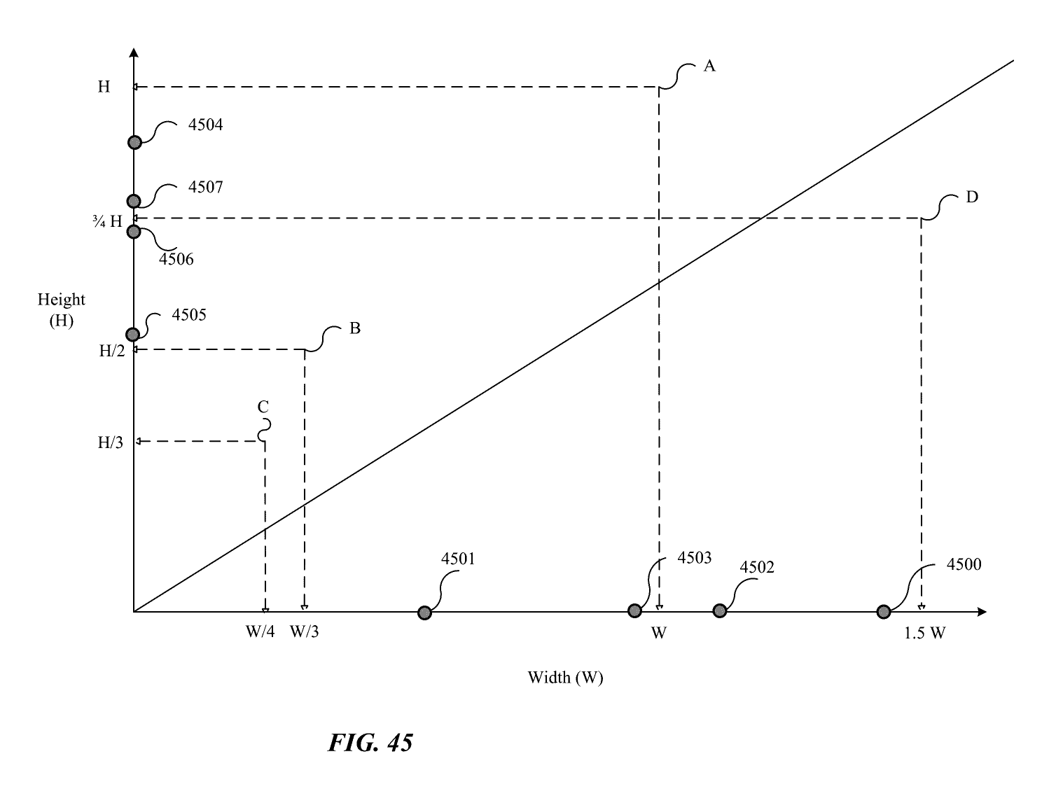

Referring to FIG. 45, this illustrates the present inventions preferred method of determining breakpoints between display devices using a systematic autonomous process for the purpose of maintaining rhythmic and polyrhythmic patterns. Here, a graph is shown representing the display types in FIG. 44, with the X-axis representing width (“W”) and the Y-axis representing height (“H”). The preferred method of the present invention consists of selecting two points, one on each axis. Beginning with width, the AI selects a point 4500 at random. It then determines whether this point lie within the scope of the accessing device's display. Assuming the device has a width of W, point 4500 will return a value that is outside the range of the display device and consequently create an error. Next, the AI will select another point halfway between 4500 and zero, in this case 4501. The AI determines 4501 is within the range of the display device. With this information, the AI picks another point halfway between 4500 and 4501, in this case 4502. Point 4502 is found to lie outside the range of the display device and consequently creates another error. With this information, the AI picks another point halfway between 4502 and the last valid point 4501. In this case, it selects 4503 and determines that 4503 is valid. This process is repeated until the precise breakpoint width is found for the device's display type.

This method is now repeated for height. First, the AI selects a point 4504 at random. It then determines whether this point lie within the scope of the accessing device's display. Assuming the device has a height of ¾ H, point 4504 will return a value that is outside the range of the display device and consequently create an error. Next, the AI will select another point halfway between 4504 and zero, in this case 4505. The AI determines 4505 is within the range of the display device. With this information, the AI picks another point halfway between 4504 and 4505, in this case 4506. Point 4506 is found to lie inside the range of the display device and consequently returns as valid. With this information, the AI picks another point halfway between 4506 and the last invalid point 4504. In this case, it selects 4507 and determines that it is invalid. This process is repeated until the precise breakpoint height is found for the accessing device's display type.

With breakpoint information for width and height ascertained, the AI may now assign an appropriate pre-designed template, if one exists, or in the alternative create a new one that is more ideal for the display type accessing the webpage. The result is an autonomous webpage design system, which may alter its designs for an infinite number a display devices and maintain or maximize the quality of rhythmic and polyrhythmic harmony of published webpages throughout all devices.

The invention claimed is:

1. A computer-implemented system, comprising:
a content flattening engine, which in operation,
accepts a plurality of content from a dynamically aggregated feed of content or from an user input;
parses and dissects said content into units of text and or media file and recording a plurality of attributes and properties of said units;
categorizes said units based on said attributes and said properties;
a content enrichment engine, which in operation,
enriches said units according to said attributes and said properties by reformatting and resizing said units into a plurality of processed units for optimization of harmonious fitment and displaying performance of a layout;
a layout engine, which in operation,
accepts said processed units and matching said processed units to said layout wherein said layout is selected from a repository of layout templates;
a presentation engine, which in operation,
integrates said processed units into a designated position of said layout;
requests said enrichment engine to further reformat said processed units in order to snug fit said processed units into said layout resulting one or more final ready layouts;
presents said one or more final ready layouts for said user to select;
a predicitive analysis engine wherein in operation said predicitive analysis engine compile the records of the selection of final ready layouts of said one or more user into a prediciative anaylsis database and use said database to yield individually relevant final ready layouts by altering the operation of said content flattening engine and saif content enrichment engine and said layout engine and said presentaton engine wherein said predicitive analysis engine utilizies sotchastic matrix to optimize its results.

2. A method comprising
accepting a plurality of content from dynamically aggregated feed of content or an user input;
parsing and dissecting said content into units of text and or media file and recording a plurality of attributes and properties of said unit;
categorizing said units based on said attributes and said properties;
enriching said units according to said attributes and said properties by reformatting and resizing said units into a plurality of processed units for optimization of harmonious fitment and displaying performance of a layout;
accepting said processed units and matching said processed units to said layout wherein said layout is selected from a repository of layout templates;
integrating said processed units into a designated position of said layout;
requesting said enrichment engine to further reformat said processed units in order to snug fit said processed units into said layout resulting one or more final ready layouts;
presenting said one or more final ready layouts;
compiling the records of the selection of said final ready layouts of said one or more user into a prediciative anaylsis database and use said database and using a sotchastic matrix to yield individually relevant final ready layouts by altering the operation of said content flattening engine and said content enrichment engine and said layout engine and said presentaton engine.
